(19) United States
(12) Patent Application Publication
(10) Pub. No.: US 2004/0215566 A1
(43) Pub. Date: Oct. 28, 2004

(54) Automatic teller machines (ATMs) management

(76) Inventor: Thomas F. Meurer, Westwood, MA (US)

Correspondence Address: PERKINS, SMITH & COHEN LLP, ONE BEACON STREET, 30TH FLOOR, BOSTON, MA, 02108, US

(21) Appl. No.: 09/990,755

(22) Filed: Nov. 14, 2001

Related U.S. Application Data
(60) Provisional application No. 60/255,985, filed on Dec. 15, 2000.
(60) Provisional application No. 60/291,864, filed on May 18, 2001.

(51) Int. Cl. G06F 17/60

(52) U.S. Cl. 705/43

(57) ABSTRACT

An ATM management system providing terminal definition and deployment, cash management, contractual terms and conditions, data recording and reconciliation among separate data entities, income and expense management and overall operational visibility into and controllability of substantially the entire business surrounding multiple ATM terminal installations and multiple partner arrangements related thereto, enabling terminal owners or partners to know how to download and utilize real time data generated at the ATMs per se and make use of it in efficiently managing ATMs.

### CROSS REFERENCE TO RELATED APPLICATIONS

This application takes priority from Provisional Applications Ser. Nos. 60/255,985 filed Dec. 15, 2000 and 60/291,864 filed May 18, 2001, the disclosures of which are incorporated herein by reference as though set out at length herein.

### FIELD AND BACKGROUND OF THE INVENTION

This invention relates generally to transactions and services management and more particularly to managing all aspects of the operation of automatic teller machines (ATMs).

ATMs include but are not limited to cash dispensing machines deployed by banks and other proprietors that allow customers to identify themselves via a bank card or credit card, and obtain cash for a charge to their account. ATMs were used initially to provide cash dispensing services to customers during non-banking hours and/or at locations of convenience. ATMs have generally been a cost center to banks that offer the service in order to attract and retain customers.

The term “ATM” as used herein includes (unless otherwise indicated for a narrower usage in specific instances) the familiar deployed cash dispensing terminals found in bank branch lobbies and also in secure remote locations rented by banks and the underlying infrastructure for servicing such terminals. It also includes similar terminals placed in stores and kiosks. It also includes terminals and infrastructure with other functions such as point-of-sale (POS) terminals, scrip machines and other analogs or extensions of the cash dispensing ATM concept as now known or hereafter revised or supplemented.

Scrip machines are a special kind of ATM that operate in a similar fashion to cash dispensing machines but are cashless, issuing a paper chit that can be taken to the merchant's counter to be exchanged for cash; they eliminate an expensive component of ATMs, the “rental” of cash in the machine. Also, the machine itself is less costly because it is not required to be a secure cash dispenser.

Cash dispensing ATMs were originally installed by banks to allow their own customers to conduct certain limited transactions 24 hours per day. These original ATMs were cost centers with no income generation potential. This surcharging for an ATM cash dispensing transaction was first allowed in the United States in 1996. Banks immediately began to charge from $1.00 to $3.00 for a withdrawal transaction to ATM users who were not customers of the bank owning the ATM. Transaction surcharging has been allowed in foreign countries for many years. In addition, the cost of the ATMs themselves dropped substantially as ATM manufacturers introduced newer models. The combination of transaction surcharging and lower cost ATMs enabled the ATM business to become a profit center. Many banks and Independent Service Organizations (ISOs) have placed ATMs at many locations thought to support a reasonable number of daily transactions.

In addition to surcharge revenue, there is an emerging secondary market that offers owners of cash dispensing and scrip terminal ATMs additional revenue opportunities by, for example, surcharging customers for the dispensing of value-added non-cash items such as phone cards, stamps, and tickets of all kinds; issuing discount coupon receipts paid for by advertisers; using revenue producing preview movie clips or rolling advertisements playing on a full color monitor while the customer is waiting for his or her cash receipt or other transaction fulfillment; or negotiating eye-catching wrap-around advertisements to the outside of the unit for major consumer products.

Banks deploy on- and off-premise ATMs. On-premise ATMs are in or near bank branches and are usually connected to the bank's own private communications network. The entire cost of operation and collection of transaction surcharge fees is usually kept within bank accounting procedures. Off-premise ATMs are in public and private locations. They frequently use a dial-up phone connection to conduct a transaction, and involve many more parties in the operation and revenue sharing associated with the ATM. These off-premise ATMs are also owned and managed by ISOs who can profit from surcharge fees per transaction. Off-premise ATMs are by far the fastest growing sector of the ATM market.

Scrip terminals are placed in off-premise locations by ISOs. Scrip terminals have long been available but are becoming more popular because of their general utility and low cost. Banks, however, are generally not interested in deploying scrip terminals because they do not provide a direct benefit to bank customers.

At this time, there are approximately 350,000 ATMs installed in the U.S., with over 150 million ATM cards issued by American banks. Approximately, 50,000 new ATMs are expected to be installed each year. In the U.S. there were over 12 billion ATM transactions in 1999. These transactions yielded approximately $4 billion in customer surcharge fees and approximately $1.5 billion in interchange fees between the card issuers and transaction acquirers involved. Similar numbers apply to the ATM market outside of the U.S.

The rapid deployment of ATMs throughout the U.S. and worldwide has created a substantial management and operational challenge for the companies that own them. For a proprietor, placing ATMs requires negotiation of terms and conditions with many partners (for cash cost, merchant site fees, armored car delivery services, maintenance contracts, and many more). These partners frequently share in the ATM surcharge and interchange fee income stream. Further, the current information exchange for all aspects of the business among the ATM owners, cash suppliers, transaction processors and armored car cash delivery services is largely paper-based (versus electronic), labor-intensive and error-prone.

While the processing of individual card transactions (e.g. authorizing and clearing the transaction) is reliably and securely handled by today's on-line transaction processing companies, the cost control and management of the ATM and scrip terminal business could be far more efficient. Problem areas include cash management, cash accounting, service management, contract terms and dates, fee management, and profit management which are all handled in a mostly manual environment today.

Most cash dispensing ATMs in the U.S. dispense from $30,000 to $300,000 of cash each month. All of this cash must be recovered from individual credit or debit accounts that may be located anywhere in the world, accounted for and returned to the appropriate cash providers, and eventually replaced in the ATM. There are billions of dollars of fees generated in this process. These fees come in the form of surcharges and interchange fees. The surcharge fees are disclosed to and paid by the consumer, typically whenever the consumer uses any ATM other than those of his own bank and requests a cash withdrawal. The surcharge fee is usually around $1.50/transaction. Interchange fees are invisible to the consumer and are credited to the owner of the ATM that acquired the transaction and paid by the bank that issued the card that was used to conduct the transaction. Interchange fees are usually around $0.50/transaction and are frequently shared among the various parties involved in conducting the transaction, such as the transaction processor, the network processor and the ATM owner. Thus, there is usually a total of about $2.00 of revenue available from most cash withdrawal transactions.

Profits from ATMs can be substantial. Poor management controls, however, can diminish or eliminate this potential. Operational costs of terminals in low transaction sites or expensive service areas may exceed the fees they generate. In addition, terminal downtime, running out of cash, ordering too much cash, and paying for too many armored car visits are all inefficiencies that increase costs and reduce profits. In addition, each owner of an off-premise terminal location must negotiate site fees, equipment leases, maintenance contracts, commissions, pay state or local taxes or fees, and the like. Properly negotiating and managing these costs to generate a profit against the expected income from surcharge and interchange fees requires a range of data that is both difficult to find and hard to interpret.

This profit challenge is very difficult to overcome without a software solution specifically designed to provide visibility into and manage the entire business surrounding ATM and scrip terminal installations. While detailed transaction data is captured from each transaction by the transaction processor that executes the transaction in real time, few terminal owners or partners know how to download that transaction data and make use of it in the management of their businesses.

Banks that provide the cash for ATMs have discovered that renting cash to ATMs is an innovative and safe way to generate fees without incurring the risk of actual loans because the cash is insured and bonded at every step. Many cash providers use “vault cash” which counts as part of their federally required “cash on hand” and is not otherwise available for loan activity. Tracking this cash is a complex process because the cash may be in any of several places: in an ATM, in an armored car, in the armored car company's vault, in a federal reserve bank account, in a correspondent bank account, “in transit” to or from the ATM, or back at the cash provider's own bank. Even a small cash provider may have upwards of $10 million spread among the locations in the ATM loop just described. All this cash must be reconciled daily—a formidable challenge. Further, the generation of fees for the cash provider requires the calculation of interest based on whatever formula the cash provider is using.

Each ATM, each day, must be tracked to monitor its transaction levels, how much cash it dispensed, and whether there are any problems requiring service. Most of the cash in ATMs originates with a “cash provider” who charges a fee to the ATM owner (some ATMs get their cash from the local merchant). The cash is delivered to the ATM by an armored car service at considerable expense. The delivery may also include some maintenance such as the replacement of printer ribbons, clearing of cash jams, and other routine maintenance. The costs for these services and for the cash are determined for each ATM location by contracts which may be different at each site.

Other regular costs associated with the operation of ATMs and scrip terminals are site fees, maintenance fees, insurance costs, commissions, advertising costs, telephone line costs, and many more. The computation of these costs depends upon many factors, and must be calculated for each accounting period. Each party to these costs must be either invoiced or paid periodically for its share of the operation.

Managing ATMs is a complex, error-prone task that is done at most small and intermediate organizations by manual record keeping and/or the maintenance of multiple spreadsheets.

There are about 8,000 scrip terminals installed in the U.S. today, mostly in the Midwest and South. The growth of scrip terminals has been limited by the major network processors demanding that scrip transactions be treated as point-of-sale (POS) transactions, and refusing to allow imposition of surcharging fees on POS transactions. This practice is being contested by the regional processors that drive the scrip terminals, and the owners of the terminals who want to collect these fees, and which they are legally allowed to collect. Should scrip terminal transactions be treated as normal ATM transactions and therefore subject to surcharge fees, the growth of scrip terminals would be tremendous because of their lower acquisition cost and operating cost compared to ATMs.

There is reason to believe that the network processors will reconsider their position on the treatment of scrip terminal transactions because they might share in the fees charged if they were treated as ATM transactions instead of POS transactions. Even without this change, merchants can still charge their own surcharge fees on a scrip transaction by assessing the surcharge at the time of money exchange at the counter.

It remains desirable to have a comprehensive business system to manage the operation of ATMs, pass information among the parties in a standard format, determine the amount of revenue from multiple sources, account for the revenue sharing among the parties involved, and compute the profitability of each ATM and partner in the aggregation.

It is an object of the present invention to provide a method and apparatus to comprehensively manage the operation of ATMs, including cash and scrip terminals and other cash and value dispensing dispersed public access terminals, and the supporting network and automated management arrangement.

It is a further object of the invention to enable the user to capture in one system as useful data, and use of the data to direct, all aspects of ATM and ATM network management including assets distribution, configuration management, events.

It is a still further object of the invention to provide autonomy of the respective functions ATM cash authorization and ATM management networks.

It is another object of the present invention to provide a method and apparatus to encompass operational tasks such as determining the amount of revenue from multiple sources and to determine the shared revenue among a plurality of participating parties.

It is another object of the present invention to provide a method and apparatus to provide visibility into the management of ATMs.

It is another object of the present invention to provide a method and apparatus to increase the efficiency of ATM operation and of ATM networks and the like.

It is another object of the present invention to provide a method and apparatus to reconcile and manage ATM cash in order to generate a maximum of fees at minimum cost to attain maximum profitability.

### SUMMARY OF THE INVENTION

The above and other objects of the invention are met and problems of managing ATMs are solved by the present invention through provision of an ATM management system comprising a unique data structure of a relational database coupled with ATM management processing functions that include software based business operation, accounting and management and other business processes and procedures to deployers of ATMs.

A first preferred embodiment of the invention is a private or corporate network operating with fed-in daily transaction files from a cash authorization system. The ATM management system and cash authorization are operated in parallel by respective proprietors.

Other embodiments include, but are not limited to, private electrical and optical telecommunications connected systems of wired and wireless types and other communications forms and mobile terminals. These can include wide area network linkages and/or real time data feeds of cash authorization.

The invention assists terminal deployers by providing cash management, contractual terms and conditions management, income and expense management and overall operational visibility.

The invention includes a software solution providing visibility into and managing the entire business surrounding ATM installations. While detailed transaction data is captured from each transaction by the transaction processor that executes the transaction in real time, few terminal owners or partners know how to download that transaction data from a range of processors and make use of it in the management of their business. The invention overcomes that problem. The present invention uses this information to more efficiently manage ATMs.

The ATM management system of the invention comprises five areas of functionality that can be parsed into five modules (or other number of modules), explained for cash dispensing ATMs as a non-limiting illustration of practice of the invention, as follows:

ATM Information File (AIF) Module

An ATM Information File (AIF) module builds and manages all acquisition, configuration, asset management and disposition aspects of each terminal. Configuration data includes all hardware, software and communication components of each terminal, vendor and user supplied options, contents and purpose of each dispenser in the terminal, warranty and service contract data, all signage options, and tracking of all upgrades of upgrades to any of these items. The AIF is integrated with other modules in that it supplies the necessary and appropriate terminal information to each integrated module,

Terminal Locations (TL) Module:

A second module builds and manages all Terminal Location (TL) data. Daily activity transaction (Txn) records are collected and recorded in the Terminal Location (TL) module in conjunction with the AIF module described above for extensive review and computations. Terminals can also be combined into various groups for reporting and analysis purposes. This module will rank the terminals in order by many criteria such as transaction counts and withdrawal amounts.

Terms and Accounting Module:

The Terms and Accounting module builds and manages a database of contract terms between the user organization and all its arrangements, agreements and/or contractual commitments with various partners for each terminal. This module is then able to compute the income and expense for each partner for each accounting period (e.g. month) and produce an accounting statement to accompany either a bill or check to the partner. This module will also build an operating statement for and compute the profitability of each terminal, month by month, and rank the terminals in order by profitability.

Cash Management Module:

The Cash Management Module builds and manages a database of cash orders and replenishments for each terminal. This module keeps track of a cash balance for each terminal for which the user manages cash, forecasts when to order new cash, produces cash orders, and posts the results of cash replenishments when a delivery confirmation is received. This module then allows various analyses of the cash management operation such as total cash exposure to a given partner and the average cost of cash at a given terminal.

Event Management Module:

An Event Management Module builds and manages a database of terminal “events”. This module also provides the ability to track supply orders for terminals. This module also provides the user with the ability to define event types and monitor those events (i.e., maintenance calls, insurance issues, ownership changes, etc.). The system can support any number of categories or event types.

Taken together, the five modules of the system provide the user with a comprehensive single-source terminal management program. This system allows the user to monitor the level of activity of all terminals, track individual and total costs, assess terminal profitability, and manage terminal cash.

The present invention together with the above and other objects, features and advantages thereof may best be understood from the following detailed description of the embodiments of the invention illustrated in the drawing, wherein:

### BRIEF DESCRIPTION OF THE DRAWING

FIG. 1 is an outline of database design for implementing the system of the invention according to a preferred embodiment thereof;

FIG. 2 is a block diagram of hardware relations among users of the invention; and

FIGS. 3, 4, et seq. are typical screen displays seen in utilization of the FIG. 1-2 embodiment.

### DETAILED DESCRIPTION OF PREFERRED EMBODIMENTS

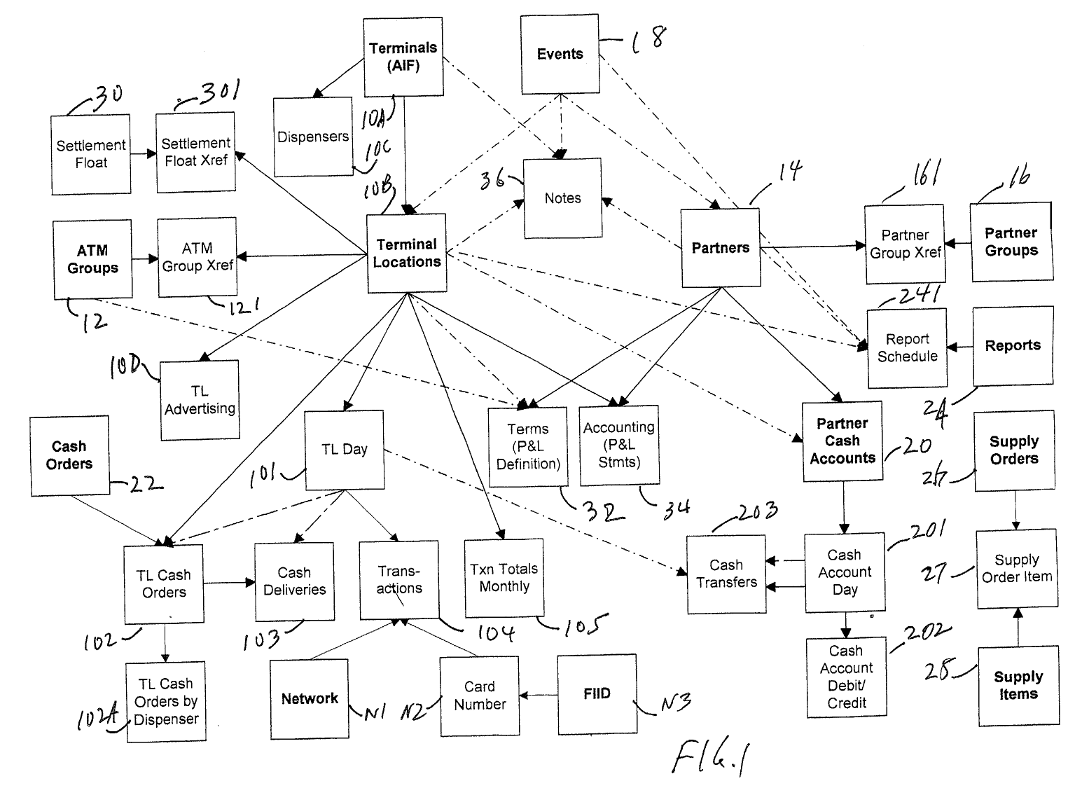

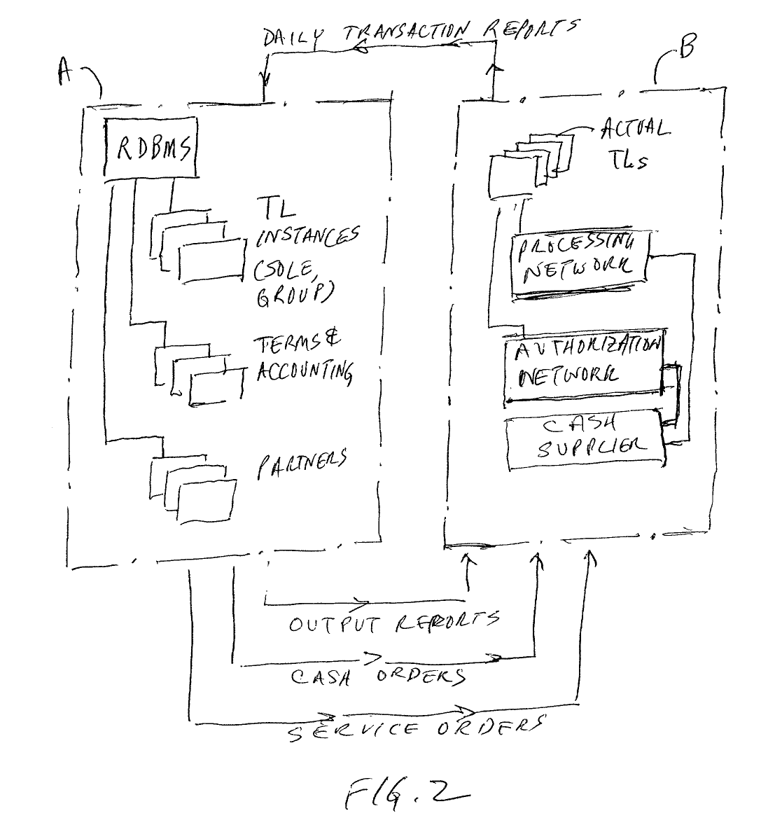

Referring now to FIG. 1, there is shown a database design for a system of ATMs management according to a preferred embodiment of the invention relating certain entities and actions of a managed ATM deployment to each other, i.e. AIF as described above 10A, and terminal (TLs), i.e. ATMs, 10B, cash dispenser 10C, ATM Groups 12, Partners 14, Partner Groups 16, Events 18, Partner Cash Accounts 20, Cash Orders 22, Reports 24, Supply order 26 and Supply Items 28. The system also comprises Terms 32 (Profit and loss, P&L, definitions), Accounting 34 and Notes generator 36.

The independent networks also provide user card numbers in a report N2 (with financial institution identification, FIID) N3. These data can be put to use in the present system.

Cross reference (Xref) tables are provided including ATM Group Xref 121, Partner Group Xref 161. Optionally Settlement Float tables 30 and Settlement Float Xref 301 can be provided. Reports can be tied to a Report Schedule table 241. ATM tables can break out data to tables for TL Day 101, TL Cash Orders 102, Transaction and monthly totals 104, 105. Additional such modules or sub-modules are Cash Account (Day) 201, Cash Account Debit/Credit 202 and Cash Transfers Instructions 203. Supply Order and Supply Items generate a Supply Order items list 27.

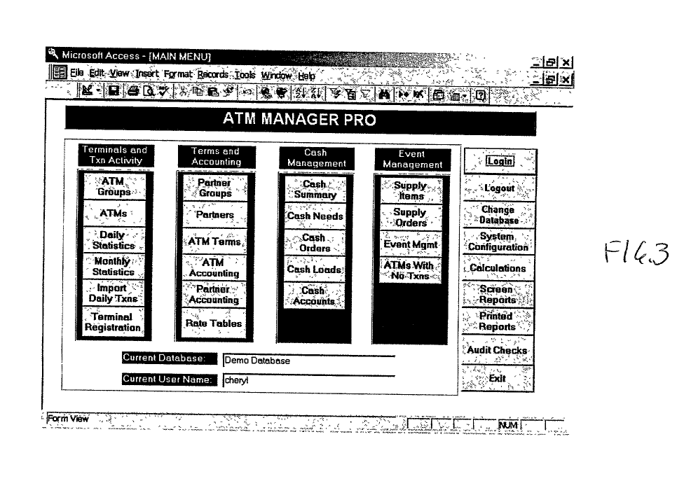

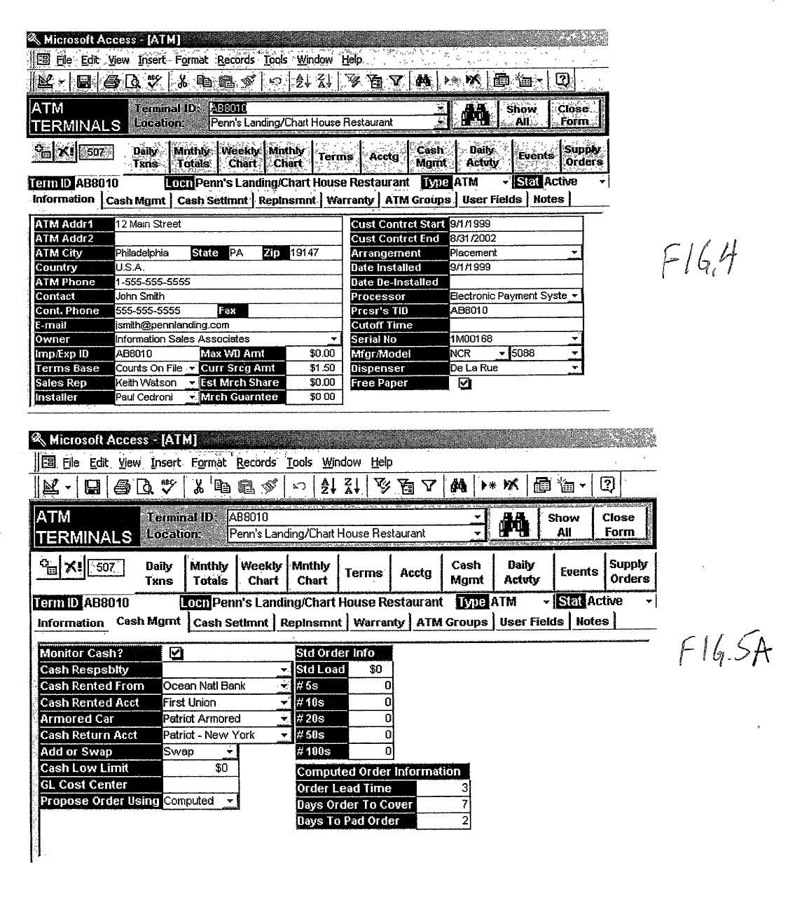

FIG. 2 shows a layout of user locations of a central data file and server and deployed ‘clients’ for cooperating system users. This figure shows the relationships of the ATM management system of the invention (A) and the processing/authorization network (B). The latter provides daily or other periodic reports (not real time feeds in this embodiment). The system of the invention provides certain reports, cash orders and service orders as described below. The distinct barriers between A and B are important for privacy, business security, computer security and integrity of operation of the respective systems. Yet, a seamless cooperation is provided between them.

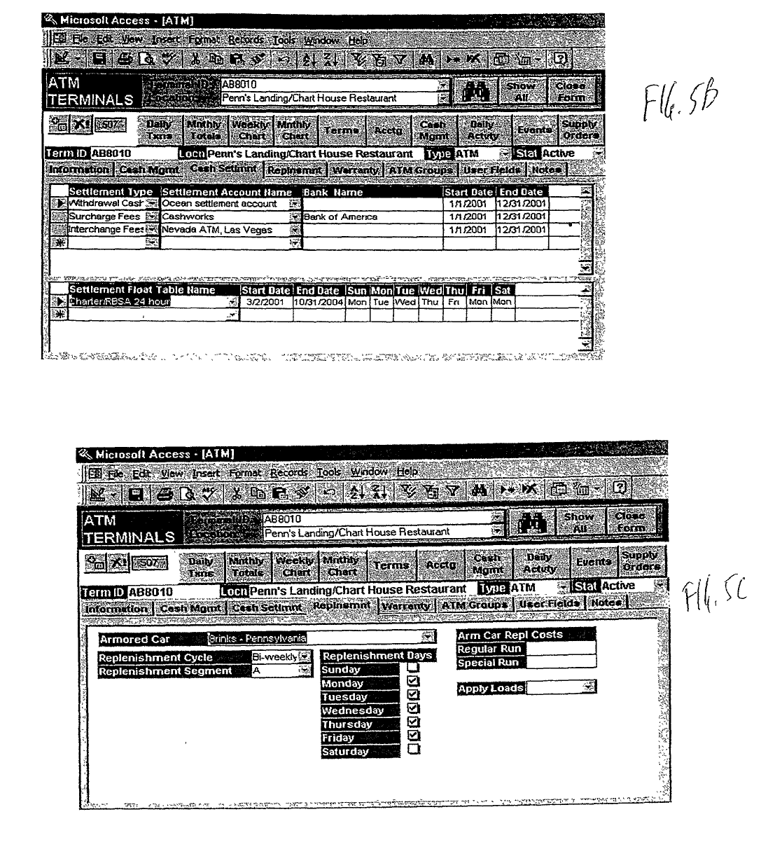

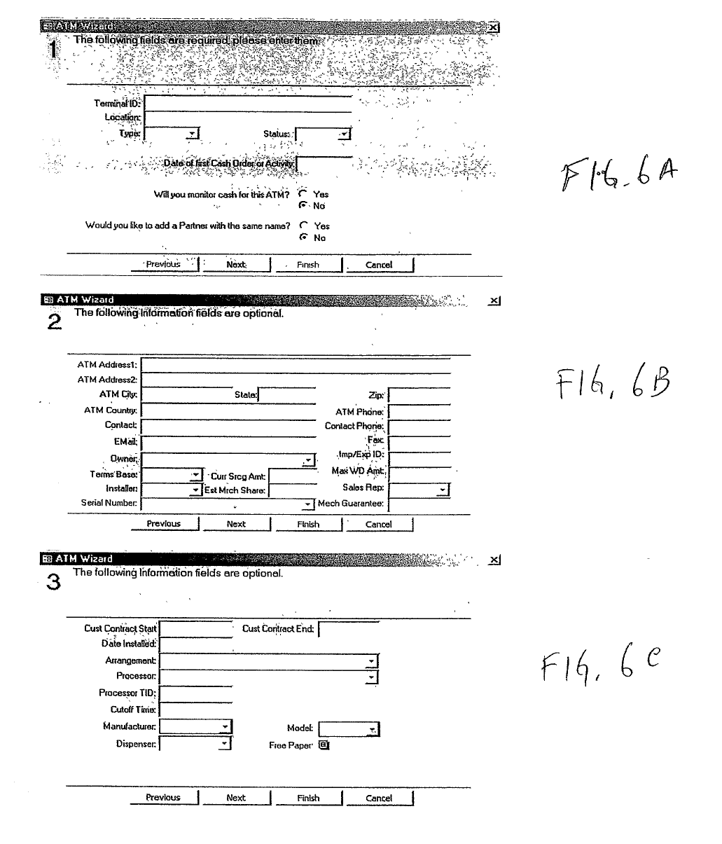

FIG. 3 is a typical main menu display for this embodiment providing launch options to the various functions (terminals, transactions activity, diverse terms and accounting that may apply, cash management function event management functions and utilities). A table of fields of processing of the engine behind the FIG. 3 display and field description is given in Appendix A.

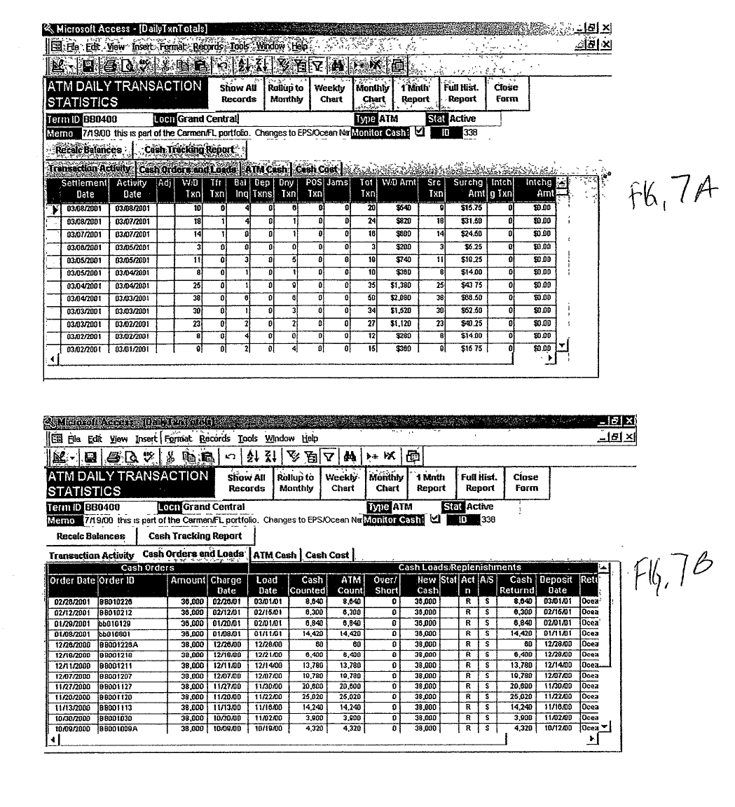

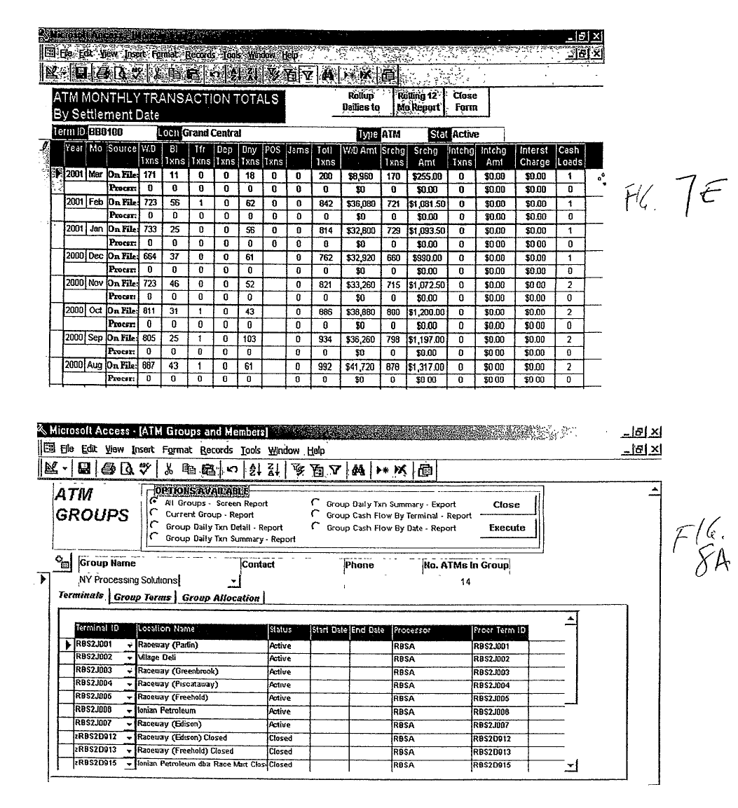

The Information Tab (FIG. 4, the same menu as FIG. 3 and the table next below in Appendix A with Information tab invoked) contains general, descriptive information on the ATM. (e.g., the model and telephone number of the ATM).

Terminal serial numbers may be required to be registered in the database before they can be entered on an ATM form. If this option has been set in the System Configuration, each serial number must be registered before use. If it is not set, then each new serial number entered in the Serial Number field on the ATM form will be added to the Master Serial Number list for the users. In either case, the system will ensure that a serial number is active in only one terminal at a time. (Please see the section on Terminal Registration below for further details.)

The status code table is user-defined. “Active” and “Closed” are used by the system and should not be changed. Additional codes may be defined. Terminals cannot be changed to a status of “Closed” unless they have a zero cash liability balance.

A Cash Management tab is provided (see FIG. 5A and at Appendix A) and it contains information that relates to ordering cash and cash deliveries. Much of the default data supplied on the Cash Order and Cash Load forms is derived from the information supplied on this tab. Cash Orders and Cash Loads are described in detail under the “Cash Management Module” section below.

A Cash Settlement tab (the display of which is represented in FIG. 5B and its fields are listed below) is provided which refers to the Settlement Float tables. These Float tables are related to interest charges and are used to indicate the delay between withdrawals at the ATM and final settlement of the funds at the Cash Supplier. Settlement Float tables are described in detail in the System Configurations section below.

An ATM's use of a Settlement table is based upon the entry (or lack thereof) of start and end dates. If an entry appears in the Start Date field for a Settlement table, the ATM will not make use of the table for transactions prior to that date. If the Start Date is left Null, the ATM uses the Settlement table from the earliest ATM transaction. If an entry appears in the End Date field, the ATM will not use the Settlement table for transactions after that date. If the End Date is left Null, the ATM applies the Settlement table to the latest ATM transaction.

A Replenishment tab (FIG. 5C and table at Appendix A below) contains information on the cash delivery company utilized by the ATM. The data that is entered into this tab should be based on what the delivery company can do. (e.g., the armored car company displayed below can replenish this ATM on a Bi-weekly schedule and the days they will deliver are Monday, Tuesday, Wednesday, Thursday and Friday.)

The replenishment segment and the replenishment days can be used to indicate the days that the armored car service is able to replenish the ATM, or can be used to indicate the users planned replenishment schedule independent of the armored car service's broader capacities.

A Warranty Tab (FIG. 5D and its table at Appendix A) documents the date the unit was shipped from the manufacturer, the manufacturer's warranty details, the date the unit was installed at the customer location, and the (perhaps) separate warranty that the user gives to the customer.

A Group tab (FIG. 5E and its table at Appendix A) contains the ATM Groups in which the ATM participates. ATM Groups are a way to collect any number of ATMs into a set for analysis or reporting purposes. An ATM Group may contain any number of ATMs, and an ATM may participate in any number of groups. ATM Groups are explained in detail later in this section.

ATMs participate in a Group based upon the entry (or lack thereof) of start and end dates. If an entry appears in the Start Date field for an ATM's participation on a Group, the ATM will not participate in the Group for transactions prior to that date. If the Start Date is left Null, the ATM participates in the Group from the earliest ATM transaction. If an entry appears in the End Date field for an ATM's participation on a Group, the ATM will not participate in the Group for transactions after that date. If the End Date is left Null, the ATM participates in the Group to the latest ATM transaction.

A User Fields tab (FIG. 5F and its table at Appendix A) is an area set up to store user-defined data items. This area is used to consistently maintain ATM-specific data that is not already part of the system Pro system. There are five categories of fields: numeric, currency, text, date, and checkbox. Each of these five categories has four fields available. The setup of User Fields is described in detail in the “System Configurations” section below.

A Notes tab (FIG. 5G and its table at Appendix A) is an area for ATM-specific notes. This area is used to record comments, changes or problems related to an ATM. Notes are entered on this form and displayed in reverse chronological order. The system is also equipped with a “tickler” process. If a future date is entered into the system under “Next Contact”, the system will display a reminder to the user on that date.

FIGS. 6A-6F show the manner of adding new ATM terminals using a wizard feature. To add a new ATM terminal, click the Add Icon button in the header of the ATM form. The ATM Wizard will begin and prompt the users through the following screens. (NOTE: Additional screens will appear if the user chooses Yes to “Will the users monitor cash for this ATM”? These screens follow.)

The user should complete as much of the information as possible in the ATM Terminals screen. Any data that is entered in this section of the database will be available in the form of defaults in other areas. This will assist in the streamlining of the data entry for the system.

The following additional screens (of FIGS. 6G, 6H, 6I) appear during the wizard process if “Yes” was selected for the answer to “Will the users monitor cash for this ATM”? on the first screen of the ATM Wizard:

Deleting an ATM terminal will remove the record from the database and all other records associated with it, including daily transaction history, agreement terms, monthly accounting terms and group associations. The delete operation is not reversible: it cannot be undone.

To delete an ATM terminal and other associated data records, the users find and display the ATM the users wish to delete. Click the Delete Icon button in the header of the ATM form. The users will receive a warning message giving the users the option to continue the deletion or cancel the delete process.

When users first enter ATM-related forms, all ATMs in the database are usually listed. As the users store more and more ATMs in the system, it may become more difficult to locate a particular ATM or a group of ATMs. On any system form, the users may use the standard Microsoft Access Edit/Find command menu option to search for certain values in certain fields in the upper section of the form. However, the system provides another more powerful search capability to locate ATMs of interest.

The “Terminal ID” and “Location” drop-down boxes allow for quick searches. In addition to the “quick” search, there is also an expanded search and filter capability that can be accessed by pressing the binoculars button. When the binoculars button is pressed, a search criteria form is opened. This form is setup so that more than one item may be selected at any time. When more than one item is selected, the system will search for any terminals that match all the selected criteria. (e.g., if the first criteria selected is “Active” under “Status” and the second is “NY” under “State”, the system will find all ATMs that are active and located in New York.).

This form is also setup so that certain fields allow “Search Strings”. “Search Strings” are searches that allow wildcard characters in the search. The following table lists the wildcard characters supported and their meaning:

| Character | Usage | Example |
|---|---|---|
| * | Matches any number of characters. | wh* finds what, |
| | It can be used as the first or | white and why |
| | last character in the character | |
| | string. | |
| ? | Matches any single alphabetic | B?ll finds |
| | character | ball, bell and |
| | | bill |
| [ ] | Matches any single character | B[ae]ll |
| | within the brackets | finds ball and |
| | | bell but not |
| | | bill |
| ! | Matches any character not in | b[!ae]ll |
| | the brackets | finds bill and |
| | | bull but not |
| | | bell |
| - | Matches any one of a range of | b[a-c]d |
| | characters. The users must | finds bad, bbd, |
| | specify the range in | and bed |
| | ascending order (A to Z, not | |
| | Z to A) | |
| # | Matches any single numeric | 1#3 finds 103, |
| | character | 113, 123 |

To search using the Search Criteria form one chooses the criteria for desired search patterns by following the guidelines above. After a user has chosen the appropriate criteria and clicked the “Search” button, the system will close the Search Criteria form and display the form from which the users launched the search. This “launch” form will only display the records that met the criteria of the user's search (use the navigation buttons at the bottom of the form to move from record to record.) To cancel the search and once again display all records, one clicks the “Show All Terminals” button.

To reset the criteria on the search criteria form, click the Reset button. All the fields on the form will return to the “_ALL” status. The users may also cancel/close the search criteria form and no filter will be applied.

Activity records reflecting the activity for each day must be captured for each ATM. These activity records can be entered into the system through the system import routines or they can be manually entered. The daily record(s) contains counts for several different types of transactions and amounts. Not all of these counts and amounts are available in every file from every processor. All information that is available from the processor is loaded into the daily activity records.

Processors cut off their collections of terminal transactions for settlement at a particular time of day, say 3:00 p.m. eastern standard time. Each processor may have a different cutoff time and procedure. Therefore, each processor's daily file to be settled that night via ACH contains transactions from two calendar days: one set that occurred from perhaps midnight to 3:00 p.m. on the current day, and one set that in this example occurred after 3:00 p.m. the previous day. The system records the transactions to the actual day they occurred, but remembers their processor settlement day as well.

There are additional complications to this process involving adjustments. Processors occasionally send adjustment transactions for a previously reported day. There are also situations where a user may need to manually enter an adjustment. To handle these cases, the system tracks multiple collections of transaction records per ATM per day.

The tracking of ATM activity is now explained (see also sample server displays at FIGS. 7A-7E). The system tracks transaction activity by both the actual activity date and the settlement date. This allows the system to properly display all transaction activity that occurred at the terminal each day, even though the transactions are settled by the processor on more than one day. This is important in order to show that potentially important activity at an ATM did not occur on the date of the settlement, but on the afternoon of the previous day. Settlement reports are available that recollect ATM transactions to their settlement day.

The system will accept one collection of transaction records for each combination of activity date and settlement date and will notify the user of any duplication. In addition, The system will accept any number of adjustment records for each activity date and settlement date combination.

The following table illustrates this capability. An ATM could, for example, have the following activity records on file:

| | Activity | Settlement | | |
|---|---|---|---|---|
| Terminal | Date | Date | Adj | Explanation |
| RBS123 | Apr. 1, 2000 | Apr. 1, 2000 | | Txns that occurred on |
| | | | | 4/1 and |
| | | | | settled on 4/1 |
| RBS123 | Apr. 1, 2000 | Apr. 2, 2000 | | Txns that occurred on |
| | | | | 4/1 and |
| | | | | settled on 4/2 |
| RBS123 | Apr. 2, 2000 | Apr. 2, 2000 | | Txns that occurred on |
| | | | | 4/2 and |
| | | | | settled on 4/2 |
| RBS123 | Apr. 2, 2000 | Apr. 3, 2000 | | Txns that occurred on |
| | | | | 4/2 and |
| | | | | settled on 4/3 |
| RBS123 | Apr. 2, 2000 | Apr. 3, 2000 | A | Adjustments for txns |
| | | | | that occurred on 4/2 |
| | | | | and settled on |
| | | | | 4/3 |
| RSB123 | Apr. 3, 2000 | Apr. 3, 2000 | | Txns that occurred on |
| | | | | 4/3 and |
| | | | | settled on 4/3 |

The system can now collect these records by either ATM activity date or by settlement date.

Daily files from processors may come to the users via a service provided by the processor (e.g. MPS MVision), via e-mail attachments, or some other method. These files should be downloaded into a folder bearing the name of the processor. The files should also be renamed to a name containing the date of the transactions (e.g. MPS20001225). Once captured in this fashion, the files may be imported into the system.

Users of the system should always import the daily detail files from processors when possible, rather than the daily summarized files. The system is able to collect more information from the detail files than is provided in the summarized files.

System import utility programs are used to avoid both the manual labor of data entry and the possibility of data entry errors. The “Import Daily Txns” button on the Main Switchboard launches the Import form:

There are four possible steps in the Import process, each of which is represented by a radio button on an import form.

Step 1: Capture Processor Daily Files

When the “Capture Processor Daily Files” button on the form is selected, another set of radio buttons will be displayed on the right. These radio buttons allow the users to select the type of processor file to be imported. Choose the file type that the users intend to import from the choices available and click the “Execute Import Step” button. A dialog box will appear to allow the users to locate the file the users wish to import. The default file locations for each file type are declared on the System Configuration screens. Once the users have pointed to the file, click the “Open” button and the file will be imported into the system Edit File. An optional report is available that will print the records that have been captured into the Edit File. This option can be set from the System Configuration screen.

The system Edit File is used to process imported daily transactions. Each imported file is placed in the Edit File. If there are records already in the Edit File, the additional file records are placed after these records. Records imported into the Edit File via one of the Processor Import Utilities are identified as being captured by a particular Import Utility in the source field. Any number of files may be imported into the Edit File. When the users choose, the users may post the records in the Edit File to the database.

Step 2: View Import Edit File

This radio button is available at any time to view the contents of the Edit File: The Edit File gives the users the opportunity to view and edit records prior to posting them to the system. Changes to an individual record can be made directly to this screen. In addition, new records can be manually added. The Edit File also allows the users to delete records. To delete, highlight the records by clicking on the gray box to the left and press the delete key.

Step 3: Print Import Edit File

A radio button is available to print the contents of the Edit File at any time. Note: the system can be set to print a list of the records that the import routine has added to the Edit File. The system can also be set to print a list of all records in the Edit File and the action that posting routine took on each. Both of these print options can be set in System Configuration on the “Parameters” tab.

Step 4: Post Edit File

Selecting this radio button and then clicking “Execute Import Step” processes each record in the Edit File. The posting routine matches the ID of records in the Edit File to the Processor's ID field value in the ATM records. If a match is found, a check is made to see if a record with the same date already exists in the database.

If there is a record in the database with the same date, the user is asked whether to replace the existing data in the database with the Edit File data or skip the replacement process and proceed. If the record does not already exist, the Edit File record is added to the ATM's daily record list in the database. Such records are marked in the Edit File as “Skipped” or “Posted” respectively.

Some records may remain in the Edit File because their ID did not match a processor's ID in the database. These records are marked as “Not Posted.” There may be cases where a proper ATM record had not been added to the database or the database contained an erroneous processor's ID. Once either one of these situations has been corrected, the Edit File may be posted again and some or all of the remaining records would then be posted and deleted from the Edit File. If the processor sent records in the file that are not of interest, the users should delete them from the Edit File.

A posting report is produced documenting the action taken on each record in the Edit File. Records that matched a terminal ID in the database are then deleted from the Edit File as they have either been posted or deliberately skipped due to a duplicate already on file.

As each new record is posted in the database, it causes various updates as necessary to fields such as the Cash Remaining in the ATM. New or modified transaction statistics and amounts are also posted into the monthly counts for the ATM. At the end of the posting run, all statistics and amounts in the system database should be accurate and in synchronization.

Note: The records in the Import Edit File may also be posted from a button on the View Import Edit File screen.

ATM stores the processor data for an ATM on a daily level so that processor changes that take place during a month will be reflected in settlement reports.

This feature requires the use of a special code in the Partner XID field (located on the “Partner” screen) for each processor used by the user's company. The following is a list of each Processor supported by the system and the corresponding code that must be placed in the XID field:

| | Partner XID |
|---|---|
| Processor File Type: | Field Code: |
| ATME | ATME |
| ATMI | ATMI |
| CoreData | CoreData |
| Concord EPS | CncrdEPS |
| Concord EPS Spreadsheet | CncrdEPS |
| First Data (USPI) | 1stData |
| Lynk Systems | Lynk |
| MoneyMaker (ACS) | MonyMakr |
| MPS | MPS |
| RBSA | RBSA |
| RBSA Daily Summary | RBSA |
| TNS | TNS |
| Universal Money | UnivMony |
| US Bank | USBank |

If the import posting routine does not find one of the above codes, an error message is displayed and the posting routine is stopped. The user may then update the Processor XID data and run the import posting routine again.

To manually enter or update daily ATM records, one uses the Edit File. The Edit File can be accessed by clicking the “Import Daily Txns” button (main menu) and then choosing “View Import Edit File”.

The manual records can be entered directly into the Edit File. No changes will be entered into the system until the record is posted. Therefore, it is important to remember that all manual changes must be posted as described above. If the users enter corrected data for an ATM, statement date, and activity date that is already on file, the users will be prompted to see whether the users wish to replace information on the database, to which the users may answer OK. The method is best when the users have data for several ATMs to add as all records can be added on one screen, subsequently posted, and a printed report can document the user's changes.

The system stores the processor data for an ATM on a daily level so that processor changes that take place during a month will be reflected in settlement reports. This requires the use of Processor XID codes as explained above. When manually entering a record in the Edit File, the appropriate XID code for the process must be typed into the “Source” field. (This is done automatically by the system when files are imported.) If the source is left blank, an error message is displayed and the posting routine is stopped. The user may then update the source field and run the import posting routine again.

The Posting routine for the system does not allow duplicate entries into the system. The system checks each record prior to posting to see if that record already exists. If the record does exist, the user is given the option to either replace or skip the record.

If the user decides to replace the existing record, the system displays the following prompt: “Would You Like The System To Replace All Duplicate Records and Not Prompt For Each One?” If the user answers “Yes”, the system replaces the duplicates without further prompting. If the user answers “No”, the system will continue to prompt for each duplicate record.

If the user decides not to replace the existing record, the system displays the following prompt: “Would You Like the System to Skip All Duplicate Records and Not Prompt For Each One?” If the user answers “Yes”, the system skips all duplicates without further prompting. If the user answers “No”, the system will continue to prompt for each duplicate record.

It is very important to ensure that data is entered into the database for every day for every terminal that is active. Missing data of course cannot be included in the system calculations and projections, and therefore could lead to erroneous results. Do not assume that missing data means no activity. Investigate the reason for missing data, and either enter the values that were missing or enter a date record with zero values to confirm that no activity took place at the ATM that day.

The Audit Checks button provides several routines that notify the user of potential problematic data. This area of the system should be checked regularly in order to keep the database up to date and accurate.

Some processors do not report on certain days (e.g. Sunday). Daily records for which the transaction counts are known to be zero are automatically generated into the database. This applies especially to days for which the ATM was not accessible (e.g. the store was closed) or perhaps out of service. The existence of the daily records is very important because cash rental charges (interest charges) still must be computed for these days.

The system has an area where transactions can be viewed/monitored. To reach this section, either click “Daily Txns” from the ATM Terminals screen or click the “Daily Statistics” button from the “Transaction Activity” module on the main menu.

The ATM Daily Transaction Statistics screen has four tabs: Transaction Activity, Cash Orders and Loads, ATM Cash, and Cash Cost. The form also has a number of command buttons located in its header.

In addition, there is a “memo” area where facts about the ATM can be displayed. (e.g., a memo may indicate that an ATM is located at a store that is closed on Sundays.)

The Transaction Activity tab (FIG. 7A) shows the individual daily transaction summary records for each combination of Settlement Date and Activity Date. Additional adjustment records may be on file, indicated by an “A” in the Adj column. The following is an example of this tab:

The most efficient way to capture these records is to import daily files provided by the processors. The system offers import utility programs for many processors. For those ATMs for which daily processor file or import utility is not available, the daily activity records must be imported manually into the Import Edit File screen and then posted.

In addition to making changes via the Import Edit File, edits may also be made directly on the Transaction Activity tab. To make a change, simply overwrite the data that is currently on the record. (i.e., to change the W/D Txns from 8 to 9 above, replace the 8 with a 9 directly in the field).

Cash Orders and Loads:

The Cash Orders and Loads tab (FIG. 7B) shows each cash order on file for the ATM and the load/replenishment status of that order.

The ATM Cash tab (FIG. 7C) shows a day-by-day accounting of the cash remaining in the ATM, together with cash order and delivery information. Daily withdrawal amounts are shown. Two important values on this screen are the cash left with confirmed deliveries (i.e. after entering the armored car report of the delivery) and the cash left with unconfirmed deliveries (i.e. assuming that all cash ordered actually get delivered). The first value is used to alert the user that cash deliveries may be overdue.

The Cash Cost tab (FIG. 7D) shows the total withdrawal amounts for each ATM each day, the settlement delay days before the withdrawals stop costing interest charges, the cash returns applied based on their assumed or specific deposit date, new cash charges, the net end of day cash balance, and the daily interest charge.

Cash orders are charged interest by the supplier from the time of the Cash Order Charge Date on each line of the order, which is usually a number of days prior to delivery at the ATM. This display shows the timing of these events in chart form.

When entering new daily data, The system always keeps an up-to-date account of ATM cash balances. Whenever a new daily record for an ATM is posted, The system automatically re-computes the daily and monthly balances for that ATM (computing monthly ATM activity is explained in the next section). This recalculation takes place for each record posted via the Import Edit File and any records edited using the Transaction Activity tab.

Daily activity records are accumulated or “rolled up” into monthly counts after each Edit File posting run. These monthly records are available by clicking on the Monthly Statistics button (see FIG. 7E) in the Terminals and Txn Activity.

Monthly accounting computations are usually based on the monthly records, not on the daily records. Once daily records have passed the period of time that they may need correction, it may not be necessary to keep them in the database.

Note that there are two sets of monthly counts for each ATM and month. One set is the accumulated set of daily counts on file for the ATM. The second set is for the processor reported counts for the same period. The processor counts must be manually input into the system.

To manually input processor counts use the Monthly Transaction Totals screen. The processor figures can be entered for the appropriate month directly on the processor “row” on the screen.

For any number of reasons, including different cutoff times for daily reporting, these sets of numbers might be different. Recording both sets of numbers in the database gives the system the ability to compare the two and alert the user to significant differences that may occur and need further explanation or investigation.

ATM Groups are a way to collect any number of ATMs into a set for analysis or reporting purposes. An ATM Group may contain any number of ATMs, and an ATM may participate in any number of groups.

An ATM Group is defined by clicking the “ATM Groups” button on the Main Menu. On a new line on this form (FIG. 8A), enter a group name and a description or purpose for the group. The users may also enter other contact information for the group. Once the ATM Group is defined, the users may add ATMs to or delete ATMs from the group by selecting the group and clicking the “Groups and Members” button at the top of the form. All current members of the group are shown. To add another ATM to the group, go to the end of the list and on the first blank line use the drop-down list to select the new ATM to be added. To delete an ATM from the list, click on the ATM's record selector to the left of the line and press the delete key on the keyboard. Click OK to confirm the delete.

ATMs may also be added to groups on the ATM Terminal form itself. The tab labeled ATM Groups lists the groups in which the ATM currently participates. To add another group to the ATM, go to the end of the list and on the first blank line use the drop-down list to select the new group to be added. To delete a group from the list, click on the group's record selector to the left of the line and press the delete key on the keyboard. Click OK to confirm the delete.

ATMs participate in a Group based upon the entry (or lack thereof) of start and end dates. If an entry appears in the Start Date field for an ATM's participation on a Group, the ATM will not participate in the Group for transactions prior to that date. If the Start Date is left Null, the ATM participates in the Group from the earliest ATM transaction. If an entry appears in the End Date field for an ATM's participation on a Group, the ATM will not participate in the Group for transactions after that date. If the End Date is left Null, the ATM participates in the Group to the latest ATM transaction.

Example: Consider an ATM that has been switched from someone else's cash to Charter Bank's cash. The ATM must be set to start participation in the Charter Bank group on the first day it uses Charter cash, so as to not include another bank's cash in group cash computations.

Transaction Activity Printed Reports:

The system is equipped with a feature that allows the user to designate whether serial numbers should be entered separately from the rest of the ATM data. This option is located in System Configuration on the Parameters tab (“Require Preregistration of Terminal Serial Numbers”). The related Terminal Registration form can be accessed from the Main Menu/Terminals and Txns Activity module:

Serial Number Master List Fields:

| Name | Description |
|---|---|
| Serial Number | Terminal serial number |
| Manufacturer | Terminal vendor/manufacturer (from user |
| | defined code table) |
| Model | Terminal model (from user defined code |
| | table) |
| Dispenser | Terminal dispenser type (from user |
| | defined code table) |
| Price | Price of machine. |
| Date Shipped | Date ATM was shipped from |
| | manufacturer |
| Warranty | Manufacturer warranty coverage |
| Coverage | |
| Warranty Start | Date manufacturer warranty starts |
| Date | |
| Warranty End | Date manufacturer warranty ends |
| Date | |
| Warranty Cost | Manufacturer warranty cost, if any, |
| | including extensions |
| Disposition | How the asset was disposed, e.g. sold, |
| | scraped, etc. |
| Memo | Notes on ATM. |

When the “Require Preregistration of Terminal Serial Numbers” option is set to “Yes”, the following apply:

All serial numbers and related machine data (manufacturer, model, dispenser, and manufacturer warranty information) must be set up in the Serial Number Master List form before it can be assigned to a Terminal in the ATM screen. The serial number field located on the ATM screen is a combo box that pulls its information from the Serial Number Master List. If a user tries to manually enter a serial number that has not already been set up, the system will display a warning message that the number is invalid and will not allow it to be entered.

When a serial number is chosen from the serial number combo box, all related serial number data (manufacturer, model, dispenser, and warranty information) is displayed and locked. This data can only be edited in the Serial Number Master List form.

If a user exits the Information tab on the ATM screen without identifying a serial number, a warning message is displayed.

If a user enters a serial number that is currently on file for another machine whose status is “Active”, the system will display a warning and will not allow it to be entered.

When the “Require Preregistration of Terminal Serial Numbers” option is set to “No”, the following apply:

There are no restrictions on how serial numbers are entered into the system. Serial numbers can be entered directly into the serial number field on the ATM screen, entered in the Serial Number Master List form, or not entered at all. Note: if no information is entered into the “Master” form, no serial numbers will appear in the serial number combo box on the ATM screen. In this instance, the number must be entered manually into the field on the ATM screen.

If serial numbers have been entered into the Serial Number Master List, they will appear in the serial number combo box. When a serial number is chosen from this combo box, the user is given the option to have the system supply all other related data (i.e., manufacturer, model).

Fields related to the serial number (i.e., manufacturer, model) are not locked and can be edited directly on the ATM screen.

If a user enters a serial number that is currently on file for another machine whose status is “Active”, the system will display a warning and will not allow it to be entered.

The purpose of the Terms and Accounting Module is to record all income and expense terms, arrangements, contracts and agreements with each business partner in an ATM: merchants, banks, processors, armored cars, and the like. Using these terms as a base. The system can compute the income and expense to each partner each month for each ATM and produce a P & L statement or financial operating statement to accompany an invoice or check to that partner. Further, The system can compute the profitability of each ATM each month and compare it to all other ATM's or ATM groups.

Each accounting term is a relationship between the ATM and a business partner. An ATM may have any number of terms associated with it, many with the same partner if appropriate. In turn, each partner may have a terms relationship with any number of ATMs, as appropriate.

Before terms can be entered, both the ATM and the Partner must be defined in the database. ATMs are defined to the database on the ATM screen in the Terminals and Txn Activity. Partners are defined to the database on the Partner form in the Terms and Accounting Module.

| Name | Location | Description |
|---|---|---|
| Name | Tab 1 | Partner name. Appears in many screens |
| | | and reports to identify the partner. |
| | | Important: see illegal character list. |
| PID | Tab 1 | Partner identification number. System |
| | | assigned identification number. |

Partner Information Tab fields:

| | | |
|---|---|---|
| Contact | Tab 1 | Contact name |
| Title | Tab 1 | Contact business title |
| Phone | Tab 1 | Contact phone |
| Status | Tab 1 | From user defined status code table |
| Business | Tab 1 | From user defined business type table |
| Type | | |
| Tax ID Type | Tab 1 | From user defined tax ID type table |
| Tax ID | Tab 1 | User's tax ID or social security number |
| Import/ | Tab 1 | Cross-reference ID for Importing/Exporting |
| Export ID | | Data |
| Address1 | Tab 1 | Partner address line 1 |
| Address2 | Tab 1 | Partner address line 2 |
| City | Tab 1 | Partner city |
| State | Tab 1 | Partner state |
| Zip | Tab 1 | Partner zip code |
| Country | Tab 1 | Country of Partner |
| Fax | Tab 1 | Partner Fax number |
| E-Mail | Tab 1 | Partner e-mail address |

Partner Group Tab:

Partner Groups serve a similar purpose to ATM groups—they gather a number of partners into a collection for reporting or analysis purposes. A Partner Group may contain any number of Partners, and a Partner may participate in any number of groups:

| Name | Location | Description |
|---|---|---|
| Group | Tab 2 | Name of the group(s) this partner belongs to |
| Name | | |
| Description | Tab 2 | Description of the group(s) |
| Contact | Tab 2 | Contact person |
| Phone | Tab 2 | Telephone number of contact |

Partner Roles Tab:

In addition to the above fields, each partner has a list of check boxes to indicate the types of roles or relationships that the partner has with the system user organization. These check boxes are used to provide lists throughout the system of only those partners that meet certain criteria. The partner roles are available by clicking the Roles tab on a Partner form.

Partner Roles Tab Check Boxes:

| Check Box | Tab | Description |
|---|---|---|
| Advertiser | 3 | Is this partner an advertiser |
| | | on ATMs |
| Armored Car | 3 | Is this partner an armored car |
| | | cash delivery service |
| ATM Owner | 3 | Is this partner an owner of ATMs |
| Bank | 3 | Is this partner a bank |
| Cash Customer | 3 | Is this partner a customer for |
| | | cash rental |
| Cash Manager | 3 | Is this partner responsible for |
| | | managing cash at one or more |
| | | ATMs |
| Cash Provider | 3 | Is this partner responsible for |
| | | providing cash |
| Corporation | 3 | Is this partner a corporation |
| Distributor | 3 | Is this partner an ATM distributor |
| Insurance | 3 | Is this partner an insurance company |
| Company | | |
| Investor | 3 | Is this partner an ATM investor |
| ISO | 3 | Is this partner an ISO or sub-ISO |
| Maintenance | 3 | Is this partner a maintenance provider |
| Co. | | of ATMs |
| Merchant | 3 | Is this partner a merchant |
| Phone Company | 3 | Is this partner a telephone company |
| Processor | 3 | Is this partner as processor of ATM |
| | | transactions |
| Salesperson | 3 | Is this partner a salesperson or |
| | | organization that might earn |
| | | commissions |

As many check boxes may be checked for each partner as is necessary to define all the roles or relationships that partner has with the system user organization.

Partner Bank Accounts Tab:

The bank accounts with which a particular partner is associated need to be designated on the Bank Accounts tab (FIG. 9A) for use in other sections of the system. The Bank Accounts Information tab is shown below:

Partner Bank Account Tab Fields:

| Name | Location | Description |
|---|---|---|
| Cash Account | Tab 4 | Name given to the cash account. Cash |
| Name | | accounts are set up in the Cash |
| | | Management module |
| Bank Name | Tab 4 | Name of the bank the partner is using |
| ABA Number | Tab 4 | ABA number of the bank |
| Account Number | Tab 4 | Account number at the bank |
| Type | Tab 4 | Type of bank account |
| Compute Interest | Tab 4 | Is interest computed on balance of this |
| | | account |
| Interest Rate | Tab 4 | Interest Rate adjustment from Prime |
| from Prime | | |

The Statement tab records information about how a partner is invoiced by tracking reports which are sent to partners.

The Statements Information tab is shown below:

| Name | Location | Description |
|---|---|---|
| Report Name | Tab 5 | Name of Report |
| Frequency | Tab 5 | Frequency of Report |
| Delivery Method | Tab 5 | Delivery method of Report |
| Start Date | Tab 5 | Start date |
| End Date | Tab 5 | End date |

The User Fields tab is an area setup to store user-defined data items.

This area is used to consistently maintain Partner-specific data that is not already part of the system Pro system. There are four categories of fields: numeric, currency, text, and date. Each of these four categories has four fields available. The setup of User Fields is described in detail in the “System Configurations” section below.

| Name | Location | Description |
|---|---|---|
| Numeric | Tab 6 | Field will hold any numeric value |
| Currency | Tab 6 | Field will hold any currency value |
| Text | Tab 6 | Field will hold any text value |
| Date | Tab 6 | Field will hold any date value |

The Notes tab is an area for Partner-specific notes. This area is used to record changes or problems related to a Partner. Notes are entered on this form and displayed chronologically by the last note entered. The system is also equipped with a “tickler” process. If a future date is entered into the system under “Next Contact”, the system will display a reminder to the user on that date.

| Name | Location | Description |
|---|---|---|
| Date | Tab 6 | Activity date for the note (e.g., date |
| | | the ATM experienced problems) |
| Type | Tab 6 | Type or category of note |
| Next Contact | Tab 6 | Date scheduled for the next contact |
| Added | Tab 6 | Date the note was added to the |
| | | system |
| Last Change | Tab 6 | Date the note was last updated or |
| | | changed |
| By | Tab 6 | User who entered the note |
| Notes | Tab 6 | A description of the reason for the |
| | | note |

When the users first enter Partner-related forms, all Partners in the database are usually listed. As the users store more and more Partners in the system, it may become more difficult to locate a particular Partner or a group of Partners. On any The system form, the users may use the standard Microsoft Access Edit/Find command menu option to search for certain values in certain fields in the upper section of the form.

However, the system provides another more powerful search capability to locate Partners of interest. The forms or screens equipped with this search capability have the following box located at the top of the screen:

The “Partner” and “Address1” drop-down boxes allow for quick searches. In addition to the “quick” search, there is also an expanded search and filter capability that can be accessing by pressing the binoculars button.

When the binoculars button is pressed, the following search criteria form is opened:

This form is setup so that more than one item may be selected at any time. When more than one item is selected, the system will search for any Partners that match all the selected criteria, (e.g., if the first criteria selected is “Active” under “Status” and the second is “NY” under “State”, the system will find all Partners that are active and located in New York.).

This form is also setup so that certain fields allow “Search Strings,” “Search Strings” are searches that allow wildcard characters in the search. The following table lists the wildcard characters supported and their meaning:

| Character | Usage | Example |
|---|---|---|
| * | Matches any number of characters. | wh* finds what, |
| | It can be used as the first or | white and |
| | last character in the | why |
| | character string. | |
| ? | Matches any single alphabetic | B?ll finds |
| | character | ball, bell and |
| | | bill |
| [ ] | Matches any single character | B[ae]ll finds |
| | within the brackets | ball and bell |
| | | not bill |
| ! | Matches any character not in | b[!ae]ll |
| | the brackets | finds bill and |
| | | bull but not bell |
| - | Matches any one of a range of | b[a-c]d |
| | characters. The users must | finds bad, bbd, |
| | specify the range in | and bcd |
| | ascending order (A to Z, not | |
| | Z to A) | |
| # | Matches any single numeric | 1#3 finds 103, |
| | character | 113, 123 |

To search using the Search Criteria form, choose the criteria by which the users would like the system to search by following the guidelines above. After the users have chosen the appropriate criteria, click the “Search” button. The system will close the Search Criteria form and display the form from which the users launched the search. This “launch” form will only display the records that met the criteria of the user's search (use the navigation buttons at the bottom of the form to move from record to record.) To cancel the search and once again display all records, click the “Show All” button.

To reset the criteria on the search criteria form, click the Reset button. All the fields on the form will return to the “_ALL” status and check boxes will be cleared. The users may also cancel/close the search criteria form and no filter will be applied.

Entering a complete set of agreement terms for each ATM, and keeping them up to date as changes occur, is extremely important. Income, expense and profitability computations are only as accurate as the terms on which they are based.

Each individual term record represents an income or expense component or intermediate computation between the ATM and a partner. Each record is composed of the following fields:

| Field | Description |
|---|---|
| Line | Line number to sequence the terms lines within |
| | an ATM. Required. Must be a unique entry |
| | within the ATM. |
| Type | Income (Inc) or Expense (Exp) to the user. |
| | May also be a Computed entry (Cmp) that is |
| | used later in the terms lines. Required entry. |
| Charge Code | System table of user defined accounting charge |
| | codes. Required entry. |
| Income From/Expense | Partner from whom income derived or expense |
| To | given. Required entry. |
| Start | Beginning effective date of this terms line. |
| | Required entry. (The system does support a |
| | Mid-Month start date. If users enter a start |
| | date of the 15^{th}, monthly computations for the |
| | line will only include transactions from the 15^{th} |
| | to the end of the month.) |
| End | Ending effective date for this terms line. |
| | Required entry. (Note: The system does |
| | support a Mid-Month end date. If the users |
| | enter an end date of the 15^{th}, the computations |
| | for the line will only include transactions for |
| | the first 15 days of that month.) |
| Base | Factor or field on which the calculation is |
| | based. Required entry. |
| Frequency | Frequency on which the calculation is based. |
| | Required entry. |
| Value, Equation, Table | Value, equation or table to apply in |
| or Actual | conjunction with the base and frequency. |
| | Required entry. When the base is “IntAmt”, |
| | “ScgAmt”, or “WdlAmt”, the word “Actual” |
| | must be placed in this field. (Note: the system |
| | supports line computations which are entered |
| | is this field. For further details, please refer to |
| | “Computed Values in Terms Lines” later in |
| | this section of the manual.) |
| Minimum Amount | The minimum amount allowed for terms line |
| | computation. If calculation total fall below |
| | this figure, the minimum amount is used. |
| Maximum Amount | When an amount is entered into this field, the |
| | system will check the calculation for the line to |
| | verify that it is equal to or less than the |
| | maximum. If the calculation is higher than the |
| | maximum, the system will substitute the |
| | maximum amount supplied. |
| Direct Deposit | Check this box if the amount determined for |
| | this terms line is deposited directly in the |
| | partner's account |
| Provide Phone | Check this box if this partner provides the |
| | phone for the ATM |

The charge code field identifies the category of charge (income or expense) represented by the terms line. Charge code values can be user defined by clicking on the System Configuration button, going to the Acctg. Charge Codes screen, and adding the new code in the next blank line at the bottom. In any case, the following standard list is delivered with the system:

| Charge | Charge | |
|---|---|---|
| Code | Code Name | Charge Code Description |
| AdvRecpt | Receipt | Charge for advertising on |
| | Advertising | receipt |
| AdvScrn | Screen | Charge for advertising on screen |
| | Advertising | |
| AdvWrap | Wrap | Charge for advertising on ATM |
| | Advertising | |
| Amort | Hardware | Charge for amortization on |
| | Amortization | equipment |
| Commisn | Commission | Payment to a salesperson |
| CshCharg | Cash Charge | Charge for cash |
| CshCost | Cash Cost | The cost of cash from the cash |
| | | supplier |
| CshInsur | Cash | Cost of insurance for cash, |
| | Insurance | hardware, etc. |
| CshLoad | Cash Load | Cost of each armored car delivery |
| CshResp | Cash | Cost for managing cash balances |
| | Responsibility | in the ATM |
| FrstLine | First Line | Cost of first line maintenance |
| | | (e.g. paper replacement) |
| InterChg | Interchange | The amount of the interchange |
| | Revenue | revenue for each transaction |
| Lease | Lease | Hardware lease or rental cost |
| Maint | Maintenance | Cost of second line maintenance |
| | | (e.g. hardware repair) |
| MgmtFee | Management Fee | Cost of management of ATM operations |
| NetAcces | Network Access | Charge to owner or merchant for |
| | | network access |
| NetSpnsr | Network | Charge for network sponsorship |
| | Sponsorship | |
| OwnerFee | Owner Fee | Fee paid to owner of ATM |
| Procssng | Txn Processing | Network fee to process transaction |
| SiteFee | Site Fee | Fee paid to site owner |
| StateCst | State Cost | Fee paid to some states for ATM |
| | | registration |
| Interchg | Interchange | Interchange transaction fee |
| | Revenue | |
| TxnSrchg | Txn Surcharge | Fee for processing a cash withdrawal |

Term Base, Frequency and Value Entries

The terms base, frequency and value entries define upon what the charge is based (base), how often it is charged (frequency) and the value or table to apply when doing the computation. Because these tables are used in computations, they may only be added to by e-Classic Systems. The entries are system defined and include the following options:

| Base | |
|---|---|
| Code | Base Code Description |
| BiqTxn | Per Balance Inquiry Transaction |
| Comptd | A computed amount based on references to other |
| | line numbers and/or arithmetic operators |
| DnyTxn | Per Deny Transaction |
| IntAmt | Use the actual interchange amount from the daily |
| | processor file. (Note: when using this as a base, |
| | the word “Actual” must be placed in the |
| | “Value, Equation, Table or Actual” field.) |
| IntTxn | Per Interchange Transaction |
| Manual | A manually entered amount, for example because |
| | it changes every month |
| N/A | Not Applicable |
| Once | Once per Frequency (e.g. once per cash load, |
| | once per month) |
| Prime | Prime Interest Rate |
| ScgAmt | Use the actual surcharge amount from the daily |
| | processor file. (Note: when using this as a base, |
| | the word “Actual” must be placed in the |
| | “Value, Equation, Table or Actual” field.) |
| ScgTxn | Per Surcharged Transaction |
| TfrTxn | Per Transfer Transaction |
| TtlTxn | Per Total Transactions |
| WdlAmt | Actual Withdrawal Amount. (Note: when using this |
| | as a base, the word “Actual” must be placed |
| | in the “Value, Equation, Table or Actual” |
| | field.) |
| WdlTxn | Per Withdrawal Transaction |

| Frequency Code | Frequency Code Description |
|---|---|
| Call | Per Call or Visit |
| Daily | Per Day |
| Load | Per Cash Load |
| Monthly | Per Month |
| Percnt | Percent (e.g. of another line#) |
| Table | Based on a Table |
| N/A | Not Applicable |

The value entry may be a number including decimal positions. It may also be the reserved word “Actual” indicating that the actual amount on the processor file is to be used. It may also be an arithmetic expression.

Rate Tables

Rate Tables are used when the charges to be computed change based on the number of transactions in a period. For example, if a merchant is paid 15 cents per transaction for the first 500 transactions per month, then 25 cents for the next 500, then 30 cents for all transactions over 1000 per month, a rate table to properly compute such charges would look like this:

Table ID: NP119; Table Name: Example

| Low | High | Value |
|---|---|---|
| 1 | 500 | .15 |
| 501 | 1000 | .25 |
| 1001 | 99999 | .3 |

Any number of rate tables can be defined using the Rate Table button on the system Main Menu. The Table ID field value is used as the key when referring to the table in Terms records.

A rate table may be designated as Incremental or Retroactive. If Incremental, each of the line values is applied within that bracket only. An example is the explanation of the table immediately above. If Retroactive, as each line is reached, the value on that line is applied to all the previous lines as well.

The Prime Rate table is simply a special case of a rate table. The Prime Rate table is available from a button on the Rate Table form, and consists of start date, end date and prime rate values for appropriate periods. Both of these tables may be added to by simply going to the next blank line in the table and adding the new rate.

The users can use other ATM Agreement Term lines in calculations for new “Term” lines. There are several ways in which “Term” lines can be manipulated using addition, subtraction, multiplication, and division. This manipulation can include interaction between lines and with other numbers (i.e., Line 1*Line 2, Line 1*0.5, Line 1*Average Surcharge).

“AvgScg” Keyword Description: when “AvgScg” is included in a terms line, the system calculates the average surcharge amount for the period and then performs the requested computation. For example, the following line can be entered in the “Equation” field: L1+L3*AvgScg. If the average surcharge were calculated to be $1.50, then the system would calculate Line 1 plus Line 3 and multiply the sum by 1.50.

An equation is entered into the “Value, Equation, Table, or ‘Actual’” field on the ATM Agreement Terms form. This equation is then used to calculate the computed amount when the “Show Acctng” button is pressed.

There are formatting rules which apply to the entry of an equation:

The equation must begin with a line number

All line numbers must have the designation “L” placed before the line number (e.g., for line number 12, “L12”)

Equation calculations are not based on operator precedence (e.g., multiplication performed before addition). Lines are evaluated in sequence from left to right. Therefore, if the users enter “L7+L3*L2”, the system will add Line 7 and Line 3 and then multiply this sum by Line 2.

There must be an operator between a line number and another number or key word.

Any number of lines may be included in the equation. However, to be included in the computation, all line numbers must occur before the line containing the new term. (e.g., if the equation is on Line 8, Line 10 cannot be part of the computation.)

The system will only recognize the following characters: L, 0, 1, 2, 3, 4, 5, 6 , 7, 8, 9, +, −, /, *, decimal points (.) and key word “AvgScg”. All other characters will be ignored during computations (e.g., spaces, parenthesis, brackets, etc.).

The percent sign (%) should not be used on any terms line.

The following are examples of how different entries will be evaluated by the system:

| Entry | Computation |
|---|---|
| L1 + L2 | Line 1 plus Line 2 |
| L1 + L2 | Line 1 plus Line 2 |
| L1 + (L2 * L4) | Line 1 plus Line 2 then multiplied by |
| | Line 4 |
| L1/[L8 − L9] | Line 1 divided by Line 8 and then Line |
| | 9 will be subtracted from the result. |
| | The brackets have not effect on |
| | calculation |
| L1 * .25 | Line 1 multiplied by .25 |
| Line 1 * .25 | Line 1 multiplied by .25 |
| Multiply L1 * L2 | Computation does not match format rules. |
| L1 + L5*AvgSgc | Line 1 plus Line 5 and then multiplied |
| | by n where n equals the average |
| | surcharge amount for the period. |
| L1.5 | Invalid Line Number |

To Enter an Equation:

Equations are entered in the field: “Value, Equation, Table, or ‘Actual’”. For an equation to take effect, the general rules as outline above must be followed and “Comptd” must be selected in the “Base”.

When the accounting is displayed for a valid equation, the equation will appear under comments. (e.g., L1+L2)

Line Types—“Inc”, “Exp” and “Cmp”:

Computed lines may be designated as type income, expense or computed. If the “Exp” or “Inc” is chosen for the “Type”, then the computed amount will be included in any totals that are generated on forms and reports. (e.g., the total on the Monthly Accounting Report will include the line.)

If the type for the computed line is designated as “Cmp”, then the computed amount will not be included in any of the totals that are generated on forms and reports. This feature would most likely be used in situations where one computed line is based on another. (e.g., a sum of several lines could be generated in a computed line and designated as type “Cmp”, then this line could be multiplied in another line by 50%. The second line could be designated as either expense or income and would be part of any totals.)

Non-Active Line Numbers:

Line numbers that do not yet exist or are not active (i.e., future “Start Date”) are not treated as invalid line numbers. These line numbers are ignored in the calculation. Therefore, the equation is L1+L2/L3 and L2 does not exist or is not active, the system will compute the following: L1/L3.

When the accounting is displayed, ignored lines are identified under comments. (e.g., for an equation of L1+L2+L3/L4 where L2 does not exist, the following will appear under comments: “Eqtn: L1+L2+L3/L4, Ign: L2”. This means that “L2” was ignored and the system added L1+L3 and then divided by L4.)

Here are some examples of terms records and their explanation:

| Base | Frequency | Value | Explanation |
|---|---|---|---|
| ScgTxn | Daily | 1.50 | Income or expense charge is |
| | | | $1.50 times the number |
| | | | of surcharged transactions |
| | | | each day |
| SurAmt | Daily | Actual | Income or expense charge is |
| | | | taken from the value on |
| | | | each transaction on the |
| | | | processor's daily file |
| Once | Monthly | 75 | Income or expense charge is |
| | | | $75.00 per month |
| Prime | Daily | +1 | Income or expense charge is |
| | | | the average daily ATM |
| | | | cash balance times (Prime |
| | | | Rate + 1%)/365 days. |
| | | | Note: the percent sign (%) |
| | | | should not be entered. |
| WdlTn | Table | NP119 | Income or expense is based on |
| | | | a table of values. The |
| | | | number of withdrawal |
| | | | transactions each month is |
| | | | processed against the amounts |
| | | | in the table. (This example |
| | | | refers to the table example |
| | | | given in the previous |
| | | | section.) |
| Comptd | Daily | L1 + | Add lines 1 and 2, subtract |
| | | L2 − | line 4, then take 50% of |
| | | L4*.5 | the net of that number |

Once a set of terms lines has been established for an ATM, that set of terms may be copied from a selected source ATM to other target ATMs, easing data entry requirements. This process is useful even if not all of the terms lines for the target ATM are the same as that of the source ATM. The full set of lines can be copied and additions, changes and/or deletions made to the set belonging to the target ATM to make it correct.

To copy a set of terms lines from one ATM to another, click the “ATM Terms” button on the Main Switchboard and select the target ATM to which the users want to copy terms lines. Note that any number of terms lines may already exist for this ATM—any terms lines copied form another ATM will be added to the set already present. Click the “Copy More Terms Lines” button. Scroll to the source ATM whose lines the users wish to copy and click the “Duplicate These Terms Lines in the Target ATM” button. The users will be returned to the Target ATM display screen and the source ATM lines will have been copied to it.

The users may also copy a terms line from one ATM by selecting the line (clicking in the gray box on the left of the line), copying it (selecting Edit/Copy of hitting Ctrl+C), and then pasting the line into the terms of any number of additional ATMs. Remember that the line number must be unique within each ATM.

Monthly accounting is the computation of an income or expense charge for each terms line for each ATM each month. For the most part, the computations take place on the monthly statistical data in the ATM Activity Module. In a few cases, such as interest charges that must be calculated on the average daily ATM cash balance, the computations take place on the daily statistical records.

The users may have the system compute monthly accounting at any time during the month, which will result month to date income and expense costs for the current month.

To compute monthly accounting income and expenses for a monthly period:

The system keeps all daily and monthly balances up to date in normal daily processing. However, to make doubly sure that the entire database is in balance before “closing” a month and printing ATM and partner reports, the users should do the following:

Using the Audit Checks button on the Main Menu, check for missing daily records and generate records for any missing days;

Click the “Calculations” button on the Main Menu;

Click the “Recompute All Daily Cash Balances” button to ensure that all cash balances are updated;

Click the “Rollup All Daily Statistics to Monthly” button to ensure that all monthly statistical records reflect the current total of the daily records;

Click the “Recompute All Monthly Accounting” button to recompute all monthly income and expenses for all ATMs;

Click the “Recompute All Cash Account Balances” button to recompute all monthly cash account balances for all ATMs.

The users may now run various reports that contain income and expense charges. A full list of reports available in the Terms and Accounting Module is given below.

Partner Groups serve a similar purpose to ATM groups—they gather a number of partners into a collection for reporting or analysis purposes. A Partner Group may contain any number of Partners, and a Partner may participate in any number of groups.

A Partner Group is defined by clicking the “Partner Groups” button on the Main Menu. On a new line on this form, enter a group name and a description or purpose for the group. The users may also enter other contact information for the group. Once the Partner Group is defined, the users may add Partners to or delete Partners from the group by selecting the group and clicking the “All Groups and Members” button at the top of the form. All current members of the group are shown. To add another Partner to the group, go to the end of the list and on the first blank line use the drop-down list to select the new Partner to be added. To delete a Partner from the list, click on the Partner's record selector to the left of the line and press the delete key on the keyboard. Click OK to confirm the delete.

Partners may also be added to groups on the Partner form itself. The Groups tab on the Partner form lists the groups in which the Partner currently participates. To add another group to the Partner, go to the end of the list and on the first blank line use the drop-down list to select the new group to be added. To delete a group from the list, click on the group's record selector to the left of the line and press the delete key on the keyboard. Click OK to confirm the delete.

The system Pro provides the user with greater flexibility in the generation of Partner related information. This feature can be accessed through the Screen Reports, Partner Custom Listing form:

The Partner Custom Listing form allows a user to sort and filter Partners in several ways such as group, location, status, role, etc., and then apply that filter to reports. The following reports are available on this form:

Print Preview—a general report on Partners (includes items such as location and correct name).

Partner Accounting (Net Due)—a report that provides a summary list of the net due on Partners Monthly Accounting for a chosen time period.

Print Partner Monthly Accounting Report—generates the “Partner Monthly Accounting Report” for a chosen time period.

Print Partner Monthly Stmts—generates the “Partner's ATM Monthly Statement” report for a chosen time period.

Print Partner Daily Transaction Activity Statements—generates the “Partner Daily Transaction Activity Statements” for a chosen time period.

Export to Accounts Payable—(Optional feature)—begins the export wizard into Quickbooks

Note: if the users have used a filter, the reports above will only include those partners within the group displayed for the chosen time period.

To generate a report based on selected criteria:

Click the binocular button in the “Select Criteria” section of the Partner Custom Listing Form. This will open the “Partners Search Criteria” form.

Select the criteria for which the users would like the system to generate a search. After selecting the criteria click the “Search” button. The system will open the Partner Custom Listing form displaying the records that match the usersr search. (Note: the system will also place the criteria used in the “Criteria” box at the top of the form.)

Select the radio button for the report the users would like to generate based on the criteria and click “Execute”. The selected report will only include those terminals that meet the criteria (and time period, if applicable).

There is an option to save and recall past search criteria on a user-level. This means that each user on the system can save and recall individual search criteria. Currently, the system can only store one search per user at any one time. Therefore, each time a user saves a new search criteria, it will replace any criteria already on file for that user.

To save search criteria, click the binocular button on the Partner Custom Listing form. Then choose the criteria by which the users would like to search/filter and click the “Search” button. When the system returns the users to the Custom Listing form, click the “Save Criteria” button below the binocular button. The search criteria is now stored in the usersr user file. The next time the users wish to call up files based on the stored search criteria, click the “Recall Criteria” button.

The following table lists some of the screen reports available based on the data in the Terms and Accounting Module. Here's how to display them:

| Screen | | |
|---|---|---|
| Report | Form | Purpose and Notes |
| ATM | Terms and | Display of all the terms or |
| Agreement | Accounting | agreement lines for each ATM |
| Terms | Module: ATM | (listing any and all partners) |
| | Terms | |
| Partner | Terms and | Display of all the terms or |
| Agreement | Accounting | agreement lines for each Partner |
| Terms | Module: Partner | (listing any and all ATMs) |
| | Screen: Terms | |
| | button | |
| ATM | Terms and | Display of the income and |
| Accounting | Accounting | expense computations for each |
| By Mo. | Module: ATM | ATM for each month (one |
| | Accounting button | month per screen) |
| Partner | Terms and | Display of the income and |
| Accnting | Accounting | expense computations for each |
| By Mo. | Module: Partner | Partner for each month (One |
| | Accounting button | month per screen) |
| Monthly | Screen Reports: | Graphically displays in a bar |
| Profit | Monthly Profit | chart the net profit for each |
| Charts | Charts | ATM for each month |
| Monthly | ScreenReports: | Lists several profit and cost |
| Profit and | Monthly Profit and | calculations over the last 6 |
| Cost | Cost Comparison | months for each ATM, and |
| Comparison | | ranks them from the highest to |
| | | the lowest |
| Monthly | ScreenReports: | Lists monthly profit |
| Profit | Monthly Profit | comparisons and ranks them |
| Comparison | Comparison | from the highest to lowest |
| Monthly | Screen Reports: | Lists monthly profit |
| Profit | Monthly Profit | comparisons by group and lists |
| Comparison | Comparison by | them by alpha |
| by Group | Group | |
| ATMs With No | Audit Checks: | Lists all terms and conditions |
| Accounting | ATMs With No | that have one or more missing |
| Terms | Accounting Terms | factors |

The following table lists the printed reports available based on the data in the Terms and Accounting Module. Here's how to produce them:

| Report | Form | Purpose and Notes |
|---|---|---|
| Partner | Printed Reports: | Listing of all partners with |
| Master | Partner Master List | contact names, addresses, phone |
| List | | numbers and e-mail addresses |
| Partner | Printed Reports: | Listing of the role and |
| Roles and | Partner Roles and | relationship check boxes for all |
| Relation- | Relationships | partners |
| ships | | |
| ATM Monthly | Printed Reports: | ATM's ranked by average |
| Profit | ATM Monthly | profit contribution and grouped |
| Comparison | Profit Comparison | by status code. |
| Monthly | Printed Reports: | Prints the average net profit |
| Profit | ATM Monthly | over the last 6 months for each |
| Comparison | Profit Comparison | ATM, and ranks them from the |
| | | highest to the lowest |
| ATM Agreement | Printed Reports: | Expired agreement terms on file |
| Terms - | ATM Agreement | for all partners of an ATM |
| Expired | Terms | |
| ATM Agreement | Printed Reports: | Agreement terms not yet in |
| Terms - | ATM Agreement | effect for all partners of an |
| Future | Terms | ATM |
| ATM Agreement | Printed Reports: | Agreement terms on file for all |
| Terms | ATM Agreement | partners of an ATM |
| | Terms- and - | |
| | Terms and | |
| | Accounting | |
| | Module: ATM | |
| | Terms: Preview | |
| | Report button | |
| Partner | Printed Reports: | Agreement terms on file for all |
| Agreement | ATM Agreement | ATMs for a partner. |
| Terms | Terms- and - | |
| | Terms and | |
| | Accounting | |
| | Module: Partners: | |
| | Terms: Preview | |
| | Report | |
| ATM Monthly | Printed Reports: | Monthly accounting |
| Accounting | ATM Group | computations for an ATM for |
| | Monthly | all partners in the ATM, based |
| | Accounting -and- | on the terms current for a period |
| | Terms and | |
| | Accounting | |
| | Module: ATM | |
| | Accounting: | |
| | Monthly | |
| | Accounting Report | |
| | button | |
| Partner | Printed Reports: | Monthly accounting |
| Monthly | Partner Group | computations for a partner for |
| Accounting | Monthly | all ATMs in which the partner |
| | Accounting | participates, for one month, |
| | and - Screen | based on the terms current for |
| | Reports: | that period. This report has a |
| | Partner Custom | large top margin so that it can |
| | Listing- and - | be printed on the usersr |
| | Terms and | letterhead paper. |
| | Accounting | |
| | Module: Partner | |
| | Accounting: | |
| | Accounting Report | |
| Partner | Screen Reports: | Monthly accounting |
| Monthly | Partner Custom | computations for a partner for |
| Statement | Listing | one ATM for one month with |
| | and- | charts of daily activity and |
| | Terms and | documentation of accounting |
| | Accounting | terms in effect. Includes the |
| | Module: Partner | user's Company Name form the |
| | Accounting: | Configuration Screen in the |
| | Monthly Statement | header of the report. |
| Partner | Screen Reports: | Monthly transaction, income |
| Transaction | Partner Custom | and expense data for all ATMs |
| Activity | Listing | in which the partner participates |
| Statement | and- | for a month. |
| | Terms and | |
| | Accounting | |
| | Module: Partner | |
| | Accounting: Txn | |
| | Activity Statement | |
| Average | Screen Reports: | ATM's ranked by monthly |
| Profit | Monthly Profit and | average profit. (Double-click |
| Contribution | Cost Comparison | on “Avg Profit Contrib” label |
| | | and click “Print Preview” for |
| | | report.) |
| Profit Per | Screen Reports: | ATM's ranked by monthly |
| Surcharge | Monthly Profit and | profit per surcharge txn. |
| Transaction | Cost Comparison | (Double-click on “Profit/Surch |
| | | Txn” label and click “Print |
| | | Preview” for report.) |
| Profit Per | Screen Reports: | ATM's ranked by monthly |
| Total | Monthly Profit and | profit per total txns. (Double- |
| Transactions | Cost Comparison | click on “Profit/Surch Txn” |
| | | label and click “Print Preview” |
| | | for report.) |
| Interest Per | Screen Reports: | ATM's ranked by monthly |
| Surcharge | Monthly Profit and | interest per surcharge txn. |
| Transaction | Cost Comparison | (Double-click on |
| | | “Interest/Surchg Txn” label and |
| | | click “Print Preview” for |
| | | report.) |
| Armored Car | Screen Reports: | ATM's ranked by armored car |
| Expense | Monthly Profit and | expense per surcharge txn. |
| Per Surcharge | Cost Comparison | (Double-click on “ArmCar |
| | | Exp/Surchg” label and click |
| | | “Print Preview” for report.) |
| ATMs With No | Audit Checks | Lists all terms and conditions |
| Accounting | | that have one or more missing |
| Terms | | factors (click “Preview Report”) |

The system Cash Management Module tracks cash balances in each ATM, provides cash ordering functions, records armored car ATM cash replenishment actions, and keeps ledgers of cash amounts or liabilities at various locations such as the ATM itself, bank accounts, armored car depots and selected partners. The Cash Management Module anticipates cash shortages at ATMs and suggests cash orders to replenish the cash before it runs out.

In the ATM record display (Terminals and Txn Activity) there are a number of fields associated with the cash management function. If the users intend to manage or track cash balances for an ATM, the “Monitor Cash” check box in the ATM record must be checked. This check box indicates to the Cash Management Module that the ATM should appear on its various screens.

In the system Terminals and Txn Activity, ATM cash withdrawal activity is captured daily from processor-supplied information or manual data entry. This allows the Cash Management Module to compute the remaining cash balance in the ATM, and sets the stage for the cash replenishment functions described below.

Cash Accounts are bank or vault cash accounts to which cash is deposited or from which cash is withdrawn. Each cash order withdraws cash from a cash account for delivery to ATMs. The account may be the main cash supplier account (e.g. a bank account) or some other cash account (e.g. at an armored car location) where sufficient cash is available. When cash is returned from a cash load because the load was a swap or because all the cash ordered could not be added to the ATM for some reason, the returned cash must be deposited into an available bank account.

Money in cash accounts may be designated as interest bearing or not. For example, cash in an armored carrier's vault may be interest bearing while cash returned to a main source of cash account may not be interest bearing.

Money may be transferred between bank accounts. For example, the users may direct or armored car carrier to transfer excess funds kept in their account back to the main bank account in order to reduce interest costs.

The total cash exposure of a group of ATMs may be tracked as the total of cash in ATMs or due to be delivered to ATMs and the total of cash held in various cash accounts.

Cash Accounts may be viewed by clicking the Cash Account button on the Main Menu. To see the detail withdrawals and deposits to any cash account, click the Account Details button. In general, withdrawals from and deposits to cash accounts are the byproduct of The system transactions such as cash orders and ATM loads, and no direct maintenance of the cash account transactions is necessary. The users may print a statement for any period for a cash account by clicking the Cash Account Activity button on the Printed Reports

To open a cash account, click the Add New Cash Account button on the Cash Account screen, enter a name for the account, select a partner that owns the account, and check the Compute Interest box if money in the account is interest bearing. Several other optional fields are available on the form to further document the cash account if the users wish. Close the form and the new account is available for use.

To view a daily summary of account activity, click the Account Details button on the Cash Account screen. The following Cash Account Transactions will be displayed:

Cash account transactions are deposits to or withdrawals from the account. Deposits can occur by cash being returned from an ATM (e.g. a swap or all the cash would not fit) or cash transferred from another account. If cash is returned from an ATM, the Terminal ID appears in the Terminal ID column. If cash is transferred from another account, the Account Name appears in the Transfer Acct column. Withdrawals occur when a cash order is placed on the account. The Cash Order ID will appear in the Order ID column. Dates on which there are no account transactions will still appear in the list, as interest may need to be computed on the account balance on those days.

Cash account balances indicate where the user's money is located. To make the best use of the money the users may need to transfer it from one location to another. To transfer money directly between two cash accounts, click the Cash Acct Transfers button on the Cash Account screen and the following screen will be displayed:

Select the account sending cash, the account receiving cash, and the date and amount of the transfer. The users may optionally enter a comment or note for this transfer to help document the reason for the transfer. Click the Post Cash Transfer button to post the transfer to the database.

Click the Review Cash Transfers button on the Cash Account Transfers screen to change information about any cash transfer the users have already posted:

All cash transfers on file are listed on the screen. The display may be sorted by any column by double-clicking on the corresponding column header. Find the transfer the users wish to change. Enter only the changes necessary in the fields at the top of the screen and click the Post Changes button. The system will make the necessary changes and update all cash account balances. Click the Delete Cash Transfers button on the Cash Account Transfers screen to delete a cash transfer the users have already posted:

All transfers currently within the system will be listed on this screen and assigned a sequence number. The display may be sorted by any column by double-clicking on the corresponding column header. To delete a transfer, find the transfer the users wish to change, enter its “Seq #” in the field at the top of the form and click the delete button. The system will delete the cash transfer from all accounts.

The following fields occur on the master ATM record display using the Cash Management Tab, and pertain to the cash management function. Complete entry of this information provides for speedy cash management operations.

| Field | Description |
|---|---|
| Monitor Cash | A check box indicating that cash is to be |
| | monitored (viewed on certain forms and charts) for |
| | this ATM. Certain ATM information will not |
| | appear in the Cash Management screens unless |
| | this box is checked |
| Cash Responsibility | Pointer to partner that is responsible for cash |
| | management |
| Cash Rented From | Pointer to partner from whom is rented |
| Cash Rented | Pointer to a cash account that is the main source of |
| Account | cash for this ATM |
| Armored Car | The normal armored car service that delivers cash |
| | to this ATM. Only those partner records show in |
| | this drop-down list that have been checked as an |
| | armored car service. |
| Cash Return | Pointer to the cash account used to deposit |
| Account | returned funds from this ATM |
| Add or Swap | Is the normal cash replenishment operation an Add |
| | or a Swap. If no entry is made in this field, the |
| | operation is assumed to be a Swap. |
| Cash Low Limit | If the low point for cash replenishment planning |
| | purposes is not zero, enter the desired cash low |
| | point (e.g. 500) |
| GL Cost Center | A General Ledger account code for this ATM. |
| | Used to provide an interface report to the user's |
| | G/L system. |
| Propose Order | Indicates to the cash forecasting system how to |
| Using | suggest a new order amount. Standard indicates to |
| | use the standard amount; Computed indicates to |
| | compute an amount abased on the average |
| | withdrawals times the number of days to cover |
| | plus pad days. |
| Standard Load | The normal cash replenishment amount |
| Amount | |
| Number of 5s | The number of $5 bills in the normal cash |
| | replenishment amount |
| Number of 10s | The number of $10 bills in the normal cash |
| | replenishment amount |
| Number of 20s | The number of $20 bills in the normal cash |
| | replenishment amount |
| Number of 50s | The number of $50 bills in the normal cash |
| | replenishment amount |
| Number of 100s | The number of $100 bills in the normal cash |
| | replenishment amount |
| Order Lead Time | The expected lead time in calendar days from date |
| | of issuing order in the usersr department to the |
| | date of armored car pickup. |
| Days Order To | The number of days a computed order amount is to |
| Cover | cover |
| Days To Pad Order | The number of pad days to add to the Day Order |
| | To Cover days in computing the suggested order |
| | amount |

Deposits to the ATM are applied before withdrawals. This only affects the ATM cash balances for swaps. Adds are not affected. This will have some affect on the Cash Needs/Forecasting because the ATM balance will be somewhat lower at the end of the day for Swaps. Cash Cost interest calculations are not affected by this change.

Cash balances for ATMs are (re)computed whenever any of several events occur:

the cash withdrawal amount in an existing daily record is changed;

records from the Import Edit File are posted to the database;

a cash order is posted to the database, thereby updating the cash balance with pending deliveries field,

a cash load is posted via the Cash Load screen, thereby updating the cash balance with confirmed deliveries field, or

cash load information is changed manually in an existing daily record.

In each of these cases, after the new entry or modification is made to the database, The system will immediately re-compute the daily ending cash balances affected by the change, and roll that balance forward through all more recent activity on file.

The Cash Summary button on the Main Menu provides comprehensive information about the cash usage history of the ATM, the current cash status, and projections about future cash usage. The Cash Summary form looks like this:

This screen has four parts:

Daily Cash Remaining Chart

This chart shows the daily cash balance at the end of each day in the ATM. The chart displays data for the last six months, if there is that much history in the database. This chart can be very useful in analyzing the rate at which cash is being withdrawn, and the frequency and amounts of cash loads to the ATM.

Cash Summary

The cash summary box shows the following information:

| Field | Description |
|---|---|
| Today Is | Today's date |
| Last ATM | Last date for which a daily record is on file. Helps |
| Data | determine how current the projections below will be. |
| Cash Left | Amount of cash left in the ATM on the Last Data date |
| Then | above |
| Average | Average withdrawal amount per day. The number of days |
| With- | included in this calculation is set in the system |
| drawals/ | configuration. |
| Day | |
| Days Left | Computation of how many days of cash are left in the ATM |
| from | based on the Avg WD/day |
| Today | |
| Out Of | Computation of when the ATM will run out of cash based |
| Cash | on the above calculations |
| Add or | Is the ATM marked for a regular Add or Sap operation |
| Swap | |
| Low Limit | Lowest amount of cash to be kept in the ATM. |
| Base | Base a proposed order on either the Standard amount or a |
| Order | Computed amount |
| On | |
| Standard | The standard cash load amount, taken from the entry in the |
| Order | cash management section of the ATM record |
| Amount | |
| Standard | Computation of how many days the standard load amount |
| Order | will last based on the Avg WD/day |
| Will Last | |
| Order | For a computed order amount, the number of days the order |
| Duration | is to cover |
| Pad Days | For a computed order amount, the number of pad days to |
| | add to the Order Duration days |
| Computed | The result of adding the number of Order Duration days and |
| Order | Pad Days, and multiplying the total by the average |
| Amount | withdrawal amount (which is based on the number of days |
| | specified in the System Configuration screen) |
| Computed | The number of days that the computed amount will last |
| Order | |
| Will Last | |
| Replenish- | The desired replenishment cycle for this ATM |
| ment | |
| Cycle | |
| Replenish- | For a replenishment cycle of Bi-weekly or monthly, a |
| ment | selection of the “A” week or the “B” week |
| Week | |
| Replenish- | The days of the week that the armored service will replenish |
| ment | this ATM without extra charges |
| Days | |

Cash Load History

This box contains a scroll list of the cash loads made to the ATM, their date and whether they were a cash add or canister swap

Unconfirmed and Future Cash Orders

This box contains a scroll list of any new cash orders that have been issued for the ATM, but for which the cash has not yet been delivered. The orders are designated as posted or not posted. Un-posted orders are considered works in process (i.e. incomplete) but are listed in this box for information purposes.

For more detailed analysis on the underlying data of any ATM, the users may click the Daily Transaction History button at the top of the screen to display all of the daily records on file for the ATM. Closing the Daily Transaction History button will return the users to the Cash Summary screen.

Taken together, these four parts of the Cash Summary screen give a broad view of the history, current status, cash usage projections and scheduled cash replenishments for each cash monitored ATM. The entire display can be printed by clicking the Print Preview button at the top of the screen.

The Cash Needs button on the Main Menu displays each cash monitored ATM listed in order by the estimated out-of-cash date. The Cash Needs form looks like this:

This display is useful in determining which ATMs are due to run out of cash first and what action, if any, has been taken so far in replenishing the cash. A horizontal scroll bar at the bottom of the screen allows the users to see more information on each line. The fields on this display are explained below:

| Field | Description |
|---|---|
| Est Date | Projection of the date that cash will run out of |
| Cash Out | the ATM based on the average daily withdrawal rate |
| Terminal | Terminal ID |
| Location | Terminal Location |
| Date of | Last date that processor data is on file |
| Last Txns | |
| On File | |
| Csh Left | Estimated remaining cash on the last date of |
| On Last | processor data on file |
| Txn Date | |
| Average | Computation of the average withdrawal amount per |
| With- | day based on the number of days specified in the |
| drawals | System Configuration Screen |
| Per Day | |
| Load Date | Date of last cash load |
| Load Amt | Amount of last cash load |
| A/S | Indication of whether last load was a swap or an add |
| Repl | Currently stored replenishment information. |
| Cycle/ | (Data entered into ATM Terminals Screen, Replenishment |
| Segment/ | tab.) |
| Days | |
| Order | Order date proposed by the system. The system uses the |
| Date | Delivery Date and the data entered into the “Order |
| | Lead Time” field of the ATM Terminals' Cash |
| | Management tab to determine a date by which cash should |
| | be ordered. |
| Delivery | Delivery date proposed by the system. The system uses |
| Date | the Est Date Cash Out and the data entered into the |
| | ATM Terminals' Replenishment tab (e.g., Replenishment |
| | Cycle) to determine what the next delivery date for |
| | the cash should be. |
| Order | Currently stored default order information. (Data |
| Base | entered into ATM Terminals Screen, Cash Management |
| | tab, e.g., Computed or Standard) |
| Order | Proposed cash order amount. (The order base determines |
| Amount | how this amount is calculated. For details on Computed |
| | versus Standard, please refer to the Cash Orders |
| | section below.) |
| A/S | Currently stored Add/Swap information. (Data entered |
| | into ATM Terminals Screen, Cash Management tab.) |
| Will Last | Number of days the proposed order should last. |
| (Days) | (Based on average withdrawals.) |
| Days w/ | Average withdrawals have been projected and this field |
| Cash | shows the number of days after today that the ATM will |
| after | have cash available |
| Today | |
| Days Left | The number of days left from the date of last processor |
| On Date | data on file. Note the difference between this date and |
| Of | the Days Left with Cash after Today |
| Last Txns | |
| Posted | A number appearing in this column indicates the number |
| Overdue | of cash deliveries that have been included in the Cash |
| De- | Left amount prior to today. These are deliveries that |
| liveries | have not been confirmed by entering the data from an |
| Included | armored car replenishment report |
| Estimated | The total amount of cash available to the ATM including |
| Cash | future deliveries contained in posted cash orders |
| With | |
| Future | |
| Delvries | |
| Posted | A number appearing in this column indicates the number |
| Future | of future cash deliveries that have been included in |
| De- | the Estimated Cash With Future Deliveries amount |
| liveries | |
| Included | |

Entries on this list may need deeper investigation. Double-clicking on any line of this display will produce the Cash Summary screen for the selected ATM.

A printed report of the same Projected ATM Cash Needs data is available by clicking the Preview Report button at the top of the display.

There is also a Cash Order Worksheet Report available via a button on the top of the screen. This report lists all active terminals for which the Monitor Cash box is checked, much of the same information on the ATM Cash Needs screen, and additional information such as replenishment cycle data and the system's next proposed order amount. This worksheet can be useful for both review and planning.

Cash Replenishments are considered to take place at the beginning of a day, the middle of the day, or the end of the day, depending on the user's choice. Deposits to the ATM are applied before withdrawals. This only affects the ATM cash balances for swaps. Cash adds are not affected. This will have some affect on the Cash Needs/Forecasting because the ATM balance will be somewhat lower at the end of the day for Swaps. Cash Cost interest calculations are not affected. Only posted orders are considered when computing when an ATM will run out of cash. However, on drill down to the cash chart, all orders on file will show regardless of whether they have been posted.

The Cash Summary screen and the Projected Cash Needs screen described above alert the user to additional cash needed at ATMs. The cash ordering process described here allows the user to order cash from appropriate sources to replenish cash in the ATMs. The Cash Order form looks like this:

The Cash Orders button on the Main Menu displays the Cash Orders screen. This screen lists all cash orders on file sorted by the Order ID. Each Cash Order is comprised of order header information that applies to the entire order, and order detail information where each line pertains to one ATM. One cash order can be for many ATMs but must be to one and only one cash source (e.g. bank) and one customer.

Order header information is the following:

| Field | Description |
|---|---|
| Order ID | User defined ID to uniquely identify this order. |
| From | Order originator - usually the usersr company |
| To | Organization with whom the cash order is being |
| | placed |
| Order Amount | Total amount of the detail lines of the order. This |
| | number is checked against the total of the actual line |
| | items before the order can be released. |
| Status | User defined order status code. An order in the |
| | “Released” status cannot be changed. |
| Confirmation | Response confirmation code from the Organization |
| | with whom the cash order is being placed |
| Order Date | Date the order was placed |
| Customer | The customer for whom the cash is being ordered |
| | and who will be charged interest |
| Source of Cash | The cash account from which the cash will be |
| | withdrawn |
| Instructions | Special Instructions for this cash order. |
| (see tab also) | |

Order detail lines on the order detail tab indicate for which ATMs cash is being ordered, what amount and in what denominations. The fields in the Cash Order detail lines are as follows:

| Cash Order | |
|---|---|
| Detail Tab | |
| Field | Description |
| Terminal ID | Select the desired terminal from the drop-down list. |
| Location | The location of the terminal will be automatically |
| | filled in when the terminal is selected |
| Charge Date | Date from which interest is to be charged on this |
| | ATM order amount |
| Pickup Date | Date the cash is to be picked up by the armored |
| | carrier |
| Need Date | Date the cash is needed at the ATM |
| Amount | Filled in automatically from standard ordering |
| Ordered | information in the ATM record if present. May be |
| | changed if desired. If not available from the ATM |
| | record, an entry must be made. {The order amount |
| | for a de-install Action should be 0.) |
| Action | R for Replenishment; A for adjustment amount; D |
| | for de-install. Defaults to Replenishment |
| Add or Swap | Filled in automatically from standard ordering |
| | information in the ATM record if present. May be |
| | changed if desired. If not available from the ATM |
| | record, an entry must be made. |
| 5s | Filled in automatically from standard ordering |
| | information in the ATM record if present. May be |
| | changed if desired. If not available from the ATM |
| | record, an entry must be made. |
| 10s | Filled in automatically from standard ordering |
| | information in the ATM record if present. May be |
| | changed if desired. If not available from the ATM |
| | record, an entry must be made. |
| 20s | Filled in automatically from standard ordering |
| | information in the ATM record if present. May be |
| | changed if desired. If not available from the ATM |
| | record, an entry must be made. |
| 50s | Filled in automatically from standard ordering |
| | information in the ATM record if present. May be |
| | changed if desired. If not available from the ATM |
| | record, an entry must be made. |
| 100s | Filled in automatically from standard ordering |
| | information in the ATM record if present. May be |
| | changed if desired. If not available from the ATM |
| | record, an entry must be made. |
| Armored | Filled in automatically from standard ordering |
| Car/Cash | information in the ATM record if present. May be |
| Delivery | changed if desired. If not available from the ATM |
| Service | record, an entry must be made. |

In the system, a Cash Order consists of one or more ATM Cash Order lines and has a status of either posted or not posted. Cash orders that are posted are locked to further edits while orders that are not posted are considered works in progress and may be edited.

There are two ways to generate a new Cash Order:

An order can be added in the Cash Orders screen by pressing the “Add New Order” button. This action will generate a blank order that can be completed; or—

The system can also generate a “proposed” or temporary order when the “Proposed New Cash Order” button is pressed. This order can be edited but remains temporary and will not be saved unless the word “Proposed” in the Order ID field is replaced with a unique Order ID designation before the screen is closed. The ATM Cash Order lines that are included in the order are based on the cash needs of each ATM terminal at the time the process is run. [Note: closing the Cash Order Proposal screen does not post an order. An order must be posted from the Cash Orders screen].

There are two sections to a Cash Order. The first section, located at the top of the screen contains general information relating to the order such as Order ID, Order Date, etc. This “Header” section has several required fields and verifications built into it. (e.g., the Order ID field must be completed and does not allow duplicates).

The second section of a Cash Order contains the “Body” of the order. In this section, all ATMs requiring cash loads are listed line-by-line. This section also has several required fields and verifications. Each line is checked as it is entered into the system. If any required fields are omitted, an error message is displayed and the line is not added to the Cash Order.

The system will also fill in appropriate information pertaining to an order where possible. (e.g., for each new ATM Cash Order line, it is assumed that the order is for a replenishment. Therefore, an “R” is entered into the “Actn” field automatically.)

In addition, when a terminal is selected, the system will supply any defaults that have been entered in the ATM setup screens. (e.g., if an armored car has been designated in the ATM setup screen, then it will be filled in on the ATM Cash Order line.) The system also fills in an amount for the “Amount Ordered” and number of bills. The figures that are placed in these fields are based on the following:

If the “Propose Order Using” calculation has been set to “standard” or is blank on the ATM Cash Management tab:

If data has been provided for both the standard amount and number of bills, the system will fill in the appropriate data.

If no data has been provided for either the standard amount or number of bills, the system will place $0s in the “Amount Ordered” and bill fields.

If the “Propose Order Using” calculation has been set to “computed” on the ATM Cash Management tab:

If data has not been entered into “Days To Order” and “Days to Pad” under the “Computed Order Section”, the system will place $0s in the “Amount Ordered” and bill fields.

If the “Computed Order Section” has been filled in, the system will calculate the “Amount Ordered” and:

where only one “bill” has been designated (i.e. only 20s), the system will calculate the appropriate number of bills for the computed amount.

where more than one “bill” has been designated (i.e. 10s, 20s and 50s), the system will place $0s in each of the bill fields.

where no “bills” have been designated, the system will place $0s in each of the bill fields.

The data that the system places in a Cash Order can be changed as long as an order has not been posted. If the amount is changed, the system will recalculate the number of bills. Note: this feature only works when the ATM has been setup with one standard bill type. Once an Order has been posted it is locked from any further changes. Once a Cash Order is complete and published to others, it should be posted.

It is important to “Post” cash orders when they are ready to be issued because the posting process performs a final series of checks to ensure that the order is complete and in balance. The following is a list of the verifications that the system makes:

The order has not been already posted.

The order has an “Order Date”.

The order has a “Source of Cash (Account)”.

The order has no ATM Cash Order lines with an amount ordered of $0 and an “Action” code of “R”.

The order has at least one “Charge Date”.

Each ATM Cash Order line must have an “Armored Car/Cash Delivery Service” designated.

Each ATM Cash Order line must have a “Need Date”.

The total bills on each ATM Cash Order line must equal the “Amount Ordered” for that line.

A “Total Amount” has been entered in the “Header” section and it matches the “Total Amount Order” from the sum of the ATM Cash Order lines.

If there are any problems encountered with the verification process, the order is not posted and a message is displayed describing the error.

If there were no problems during the posting process, the order is posted and locked. When an order is posted, the following takes place:

The system posts each ATM Cash Order line to the appropriate source of cash account.

The system issues a “memo post” of pending delivery records to cash tracking.

These last two processes do not occur until an order is posted.

New orders entered into the database are in an “Unposted” state and are considered open batches until Posted. Cash Orders must be “Posted” to

have them appear as a withdrawal against the Source of Cash account,

have pending deliveries posted to the individual ATMs,

be available for subsequent cash deliveries (loads), and

have the individual order lines appear on the Daily Transactions form for each ATM in the order.

A red banner will appear in the Cash Order header if the Order has not been posted. The users may add, change and delete information from the Cash Order as long as it has not been posted.

To Post a Cash Order, click the Post Order button in the form header. In order to have a successful post, there must be valid entries in the Order ID, Order Date, Order Amount, Charge Date and Source Of Cash fields. Further, the Order Amount in the header must match the total of the Order Detail lines. Posting an order “lights up” the Delivery tab on the Cash Order form.

Once a Cash Order has been posted, the banner in the form header will reflect that status and the order may not be posted again. Further, once posted, the order amount for each ATM is considered “in-transit” to the ATM and interest is charged on the amount to the ATM from the Charge Date. This timing and interest expense is reflected on the ATM Daily Transaction Statistics—Cash Tracking form.

Clicking the “Unposted Orders” button in the Cash Order form header will reduce the display to only those Cash Orders that are unposted, so that they may be located and processed more easily.

Cash Orders with no associated terminal cash load (delivery) can be edited.

Editing the Detail Line of a Cash Order

To edit the detail line of a cash order, click the edit button located on the line. The following screen will be displayed:

Any changes to the detail line can be made directly to this screen. Once all changes have been made, click the “Save Changes” button. The system will analyze the changes. If any errors are encountered (e.g., amount ordered does not match number of bills), the system will report the error and the changes will not be saved. If no errors are found the changes are saved to the order. Note: If the amount ordered has changed, the system will automatically adjust the total amount of the order.

To remove a terminal from a cash order, click the “Delete” button. A message will be displayed asking for confirmation. If “Yes” is selected, the terminal will be deleted. If “No” is selected, the terminal is not deleted.

To leave form without saving changes, click the “Cancel” button. The form will close and no changes will be saved.

To edit the main information of a cash order, click the edit button located in the top section of the cash order screen. The following screen will be displayed:

Changes to a Cash Order can be made directly to this screen, with the exception of fields with a gray background. Once all changes have been made, click the “Save Changes” button. The system will analyze the changes. If any errors are encountered, the system will report the error and the changes will not be saved. If no errors are found the changes are saved to the order. Note: The total amount of an order cannot be changed. However, the amount will be adjusted by the system if changes are made to the amount of an order detail line.

To leave form without saving changes, click the “Cancel” button. The form will close and no changes will be saved.

Cash order delivery information on the delivery detail tab reflects any deliveries recorded for individual cash order lines. These fields may not be updated on this screen—only via the separate cash delivery screens.

The fields in the Cash Order Delivery Detail tab are as follows:

| Cash Order | |
|---|---|
| Delivery | |
| Detail | |
| Tab Field | Description |
| Terminal ID | From the order detail tab |
| Location | From the order detail tab |
| Amount | From the order detail tab |
| Ordered | |
| Armored Car/ | From the order detail tab |
| Cash | |
| Delivery | |
| Service | |
| Exp Delivery | Expected delivery date |
| Delivery | Blank if delivery has not yet been made for this |
| Date | ATM cash order line. If an entry is present, the |
| | date the delivery was made. |
| Cash Counted | Blank if delivery has not yet been made for this |
| | ATM cash order line. If an entry is present, the |
| | amount of cash counted as present in the ATM |
| | before any additions |
| Cash Loaded | Blank if delivery has not yet been made for this |
| | ATM cash order line. If an entry is present, the |
| | amount of cash added to or swapped into the ATM. |
| Status | Status of delivery |
| Actn | Action for delivery |
| Add or Swap | From the order detail tab |
| Cash Retrnd | Blank if delivery has not yet been made for this |
| | ATM cash order line. If an entry is present, the |
| | amount of cash swapped out of the ATM or returned |
| | for any other reason (e.g. would not fit). |

To enter a new cash order, click the Add Icon button at the top of the screen, and proceed to enter order header and detail information.

If the user wishes, the system will prepare a suggested new cash order for the users. Click the “Proposed New Cash Order” button at the top of the screen and the system will create a new cash order with order lines for each ATM projected to run out of cash in the next 10 days and for which an outstanding cash order is not already on file. The users may add to, delete lines from, or edit the proposed lines for this suggested cash order and save it under an Order ID of the user's own if the users wish. If the users close the suggested cash order without saving it under an Order ID of the user's own, it is not saved.

After creating a new cash order, the users may wish to print a copy of the order and fax it to the cash source for processing. A button labeled “Cash Order Report” is available at the top right of the screen for this purpose. Remember, as cash deliveries are made and recorded in the Cash Loads portion of this module, certain delivery information is appended to the individual order lines to reflect those deliveries. The status of any cash order may be printed at any time and delivery information on file up to that point will be reflected on the printed report.

The Cash Loads button on the Main Menu displays the Post Cash Loads by Armored Car or Cash Source screen. This screen lists each armored car delivery service or cash supplier. For each such entity, all open ATM cash order lines (those order lines for which a delivery has not been made) are listed in sequence by date of order. The earliest order lines for each entry will be shown first, since these are the orders most likely to be delivered first.

In posting a cash load, normally the users will have some document in hand that confirms that the delivery was made on a certain date, and how the replenishment was handled. These documents should be kept in a file for later reference if needed.

Cash Loads are usually posted by ATM Terminal ID. Click the Cash Loads button on the Main Menu. This screen gives access to all open ATM cash orders by Terminal ID. The combo box (down arrow) on the Terminal ID field will offer a list of open ATM cash orders from which to choose.

There are two options available for matching cash orders. If the option button indicates “Require Match to Outstanding Cash Orders,” then only Terminal IDs with open cash order lines (those order lines for which a delivery has not been made) appear in the drop-down box.

If the option button indicates “Skip Cash Order Match Rqmt—Show All Terminals”, then all Terminal IDs are available and no attempt is made to match the cash loads entered with open cash orders. This latter choice should only be used to load historical data into the database, since as a general rule cash orders should be under the control of The system first before cash loads are posted. Using this option, when the users select a Terminal ID, The system does not fill in an order amount. The users may then enter the same six fields described above, click “Post Cash Load” and The system will log the delivery into the daily transaction records and re-compute the ATM cash balances as indicated above. The users may then continue immediately with the next cash delivery entry, repeating until the users are done

If amounts are entered in both the Cash Counted Before Additions and the ATM Count Before Additions fields, and they are not the same amount, then The system Pro calculates an over or short amount. For Adds, the net effect of the over or short remains in the ATM account balances. For Swaps, the net effect of the over or short condition is transferred to the Returned Cash Account.

If an amount is entered in the Cash Returned field, then an entry in the Deposit Account for Cash Returned must be made. The system Pro will enter a default account for the users if one has been provided in the ATM screens.

If a Deposit Date is not entered, then the deposit date is considered the same date as the Cash Load Date. Interest stops on the returned cash on the (assumed) Deposit Date.

General Facts on Open ATM Cash Orders and Pending Cash Delivery Records

In the system, a Cash Order is comprised of any number of ATM Cash Order lines. The Cash Order posting process conducts many checks on the entire Cash Order, ensuring that it is complete and in balance, and then locks the order from further changes. Unposted Cash Orders are considered to be works in process that can be modified until posted. Once a Cash Order is complete and issued to other organizations, it should be posted.

Each ATM Cash Order line is an open ATM order for that ATM until a delivery is posted against it. Once a delivery is posted for the ATM Cash Order, it is considered a completed ATM order.

When the users post a Cash Order, The system adds a pending ATM delivery record to the database for each open ATM order, that is if the order line had not already been delivered and completed (this is possible because unposted cash orders will accept deliveries for their open ATM order lines). These pending ATM deliveries will NOT show for unposted Cash Orders

In order for this process to work properly, the Need Date (or Fill Date) is a required entry on each ATM order line for a successful post of the order.

On the Daily Statistics Screen tabs, the pending cash deliveries will show an status indicator field of “*P*” in a blue color if they are pending for a future date, and an indicator field of “*OD*” in a red color if the expected delivery date has passed (overdue deliveries). The ATM Cash Order Fill Date (Need Date) field is used as the assumed date of the pending cash delivery.

After a Recalc (e.g. from a daily import) the pending deliveries and status indicators will also show on the Cash Tracking tab. Two fields are now displayed on the Cash Tracking Tab, the estimated cash left in the ATM with confirmed deliveries, and the estimated cash left including any overdue pending deliveries. (No amount is assumed to be returned from the delivery, e.g. for swaps).

The Cash Delivery Screen Terminal ID combo box shows all open ATM cash orders, whether they have a pending cash delivery record or not.

The Cash Loads Overdue screen shows all overdue cash deliveries, whether they have a pending cash delivery record or not.

When posting an actual cash delivery, the pending cash delivery is deleted and the information from the actual delivery replaces it. All cash balances are then updated.

The pending cash order information is NOT available to change on the Cash Load Changes screen as it represents open ATM orders for cash, and not confirmed deliveries.

The Cash Needs Screen and Report include overdue delivery amounts in the Estimated ATM Balance and show separately any scheduled future loads. This better identifies what ATMs need cash the soonest.

The overdue delivery status field is reset in the once-a-day startup, changing any pending deliveries whose dates have passed to overdue status.

Each cash load is treated as happening at the beginning of the day. As a result, the ATM balance is an estimated balance because the actual load could have occurred anytime during the day and the system doesn't know how many transactions during the day occurred prior to or after the actual load.

Estimated ATM Balances:

For an Add,

the cash counted adjusts the cash in the ATM

(the cash counted is taken over any potentially different amount in the ATM Count field)

For a Swap,

the cash added resets the balance in the ATM

Finding Cash Liability:

For An Add,

if the Cash Counted and ATM Counts were supplied,

the over/short amount is calculated as the cash counted−the ATM count

the ending cash liability=the previous day's ending liability

−today's withdrawals

+any new cash charged today

−any actual cash returned

+the over/short amount

if both the Cash Counted and ATM Counts were not supplied,

(there is not enough info to calculate an over or short)

the ending cash liability=the previous day's ending liability

−today's withdrawals

+any new cash charged today

−any actual cash returned

For a Swap

the ending cash liability=the previous day's ending liability

−today's withdrawals

+any new cash charged today

−the actual cash returned

To change load information on cash loads already posted, click the Change Load Info button on the Cash Loads screen:

All cash loads on file are listed in order by Terminal ID. Find the terminal owning the load the users wish to change. Enter only the changes necessary in the fields at the top of the screen and click the Post Changes button. The system will make the necessary changes and update all ATM and cash account balances.

The Cash Loads Overdue button in the header of the Cash Load screen displays all cash orders that have not been delivered and are past their expected delivery date. The list may also be printed from the same screen. The printed report may be used as a worksheet to track the missing or overdue cash loads.

The following table lists the screen reports available from the Cash Management and how to display them:

| Screen Report | Form | Purpose and Notes |
|---|---|---|
| Cash Summary | Cash Management: | Cash history, current status and |
| | Cash Summary | projections for an ATM |
| | button | |
| Cash Needs | Cash Management: | Computations of cash needs and |
| | Cash Needs button | accompanying open cash orders |
| | | for all ATMs |
| Cash Orders | Cash Management: | Catalog of all cash orders on |
| | Cash Orders button | file, with optional line item |
| | | delivery status |

The following table lists the printed reports available from the Cash Management and how to produce them:

| Report | Form | Purpose and Notes |
|---|---|---|
| Cash | Cash Management: | Cash history, current status and |
| Summary | Cash Summary: | projections for an ATM |
| | Report | |
| Cash Needs | Cash Management: | Computations of cash needs and |
| | Cash Needs: Preview | accompanying open cash orders |
| | Report | for all ATMs |
| Cash Order | Cash Management: | Documentation of each cash |
| | Cash Orders: Cash | order |
| | Order Rpt. | |
| Cash Order | Cash Management: | Documentation of each cash |
| Status | Cash Orders: Cash | order and delivery status of |
| | Order Status Rpt. | each order line |
| ATM Cash | ATM Daily | Provides detailed daily cash |
| Flow | Transaction | flow for a terminal for a month, |
| Tracking | Statistics: Cash | including withdrawals by |
| Sheet | Tracking Report Tab | settlement day, cash orders, |
| | and the Printed | cash loads, over and shorts, |
| | Reports Form | cash liability and interest |
| | | charges |
| ATM Group | ATM Group Form | Lists each ATM in a Group and |
| Cash Con- | and Printed Reports | for any period the opening cash |
| solidation | Form: Group Cash | liability, withdrawals by |
| by | Flow by Terminal | settlement day, cash orders, |
| Terminal | Button | cash loads, ending liability and |
| | | interest charges during the |
| | | period |
| ATM Group | ATM Group Form | Lists each day in a period the |
| Cash Con- | and Printed Reports | summary for all ATMs in a |
| solidation | Form: Group Cash | Group, listing the total opening |
| by Date | Flow by Date Button | cash liability, withdrawals by |
| | | settlement day, cash orders, |
| | | cash loads, ending liability and |
| | | interest charges during the |
| | | period |

The Event Management module supports the tracking of a variety of events such as supply orders, service orders, insurance claims, litigation proceedings and the like. The event types are user-defined and are defined in the System Configuration code tables.

The Supply Item form presents the detail of a supply item master file. Each item in the file contains the following fields:

| Field | Description |
|---|---|
| Part Number | Part number |
| Item Name | Unique item name |
| Status | User defined status code table. |
| | (Set up in System Configuration.) |
| Class | |
| Our Cost | The user's purchase cost |
| Price | The user's price to the customer |
| Note | Memo field for notes pertaining |
| | to the item |

To add an item to the master list, use the last line of the list (the one with an * as the record selector) to enter the new information. An item can be deleted from the list as long as it is not used on any Supply Orders. To delete an item from the file, click on the record selector of the desired record and press the Delete key.

The Supply Report button provides an alphabetical listing of all items on file.

Supply Orders are orders of items to be sent to an ATM site or business partner, and potentially billed to a customer. Supply Orders contain an order header, followed by detail lines for each item on order. The Supply Order form looks like this:

The supply order form is equipped with a Search Criteria box. This box allows the user to search by “ATM” or “Status”. When the user chooses an ATM from the drop-down menu or a type of status, all supply orders meeting that criteria will be displayed. The “filtered” records that met the criteria can be viewed by using the navigation buttons located at the bottom of the screen. The user can also return to the default view of all records by clicking the “Show All” button.

The Search Criteria box also has a feature that allows the user to view a report based on the criteria selected. By clicking the “Criteria Report”, a user can view and print a report of the currently displayed records. For example, to print a report of all “Open” supply orders, click “Open” from Status drop-down and then click “Criteria Report”. If no criteria has been selected, the “Criteria Report” will display all records currently in the system.

The following fields comprise the header information in the Supply Order:

| Field | Description |
|---|---|
| ATM Terminal ID | Selection of the ATM for this Supply |
| | Order |
| ATM Location | (Alternatively) Selection of the ATM |
| | Location for this Supply Order |
| ATM Address | (Alternatively) Selection of the ATM |
| | Address for this Supply Order |
| ATM Surcharge | Displays the terminal's surcharge |
| | transaction amount. |
| Bill To Partner ID | Selection of the ID of the Partner to |
| | Bill for this Supply Order |
| Bill To Partner | (Alternatively) Selection of the |
| Address | Address of the Partner to Bill for this |
| | Supply Order |
| Ship To Partner ID | Selection of the ID of the Partner to |
| | Ship this Supply Order |
| Ship To Partner | (Alternatively) Selection of the |
| Address | Address of the Partner to Ship this |
| | Supply Order |
| Status | Selection from the user defined table |
| Date Opened | Date the Supply Order was opened |
| Date Completed | Date the Supply Order was completed |
| Date Shipped | Date the Supply Order was shipped |
| Taken By | Selection from the user name table |
| Contact | Name of contact for supply order |
| Shipped By | Selection from the user name table |
| Shipping Method | Selection from the user defined table |
| Carrier | Selection from the user defined table |
| Payment Method | Selection from the user defined table |
| P.O. Number | PO number for supply order |
| Contact Phone | Telephone number of supply order cont |
| Mfg/Model | Manufacturer/Model for terminal |
| Subtotal Amount | Total of the extended price (quantity |
| | times price) of all order lines. System |
| | computation. |
| Tax | Tax amount - entered by user |
| Shipping and | Shipping and handling cost - entered |
| Handling Cost | by user. |
| Total Order Cost | Total of the Subtotal amount, tax and |
| | shipping and handling. Computed by |
| | the system |

Supply Order Detail Lines

The following fields comprise the order lines of a Supply Order:

| Field | Description |
|---|---|
| Line Number | A line number to identify and sequence |
| | the display of items on order |
| Part Number | Selection from the items by Part Number |
| Item Name | Selection from the items available to sell |
| Quantity | Quantity of the item on this line to order |
| Price | The users price to the customer (the price |
| | cannot be changed on this form) |
| Cost | Quantity time price. [Computed by the |
| | System.] |

To add a new order, click the add button located at the top of the form. A blank supply order form will be displayed. There are several drop down boxes located in the “ATM”, “Bill To” and “Ship To” sections of the form to assist the users in choosing appropriately. If no information is entered into the “Bill To” and “Ship To” sections of the form, the system will use the ATM's location once a terminal is chosen. [Note: the “Bill To” and “Ship To” sections of the form involve Partners. Therefore, for the default to work, the ATM terminal must also be listed as Partner.]

The header information should be filled in as completely as possible. Note: if the “Bill To” the “Ship To” information is the same, the users may leave the “Ship To” blank. The users must complete the “header” part of the form prior to entering the details of the order in the “Order Detail” section. Once the header information has been completed, the users can begin to enter the order details.

A Supply Order may contain as many order lines may as needed. To add a line to a Supply Order, type an entry on the next available line at the end of the order. As the users enter information into the order details section of the form, the system will calculate totals based on the information that was entered into “Supply Items” (described earlier in this section.) To delete a line from an order, click the record selector to the left of the desired line, then press the Delete key.

Once the order form has been completed, the order can be viewed and printed by pressing the “Print Supply Order” button located at the top of the form. This will only print the order that is currently on display. If the users need to print another order, the users must first display that order.

Supply orders cannot be deleted from the system. If the users wish to “remove” an order from the system, the order can be marked with a “void” status.

Event Management allows the opening of a ticket to track various events such as ownership changes, bank account changes, insurance issues, installation steps, litigation matters and the like. The event types to be tracked are user defined in the System Configuration.

The following fields comprise the header information of an Event:

| Field | Description |
|---|---|
| Event ID | Unique system assigned number for this Ev |
| Event Type | Selection from the user defined table |
| Status | Selection from the user defined table |
| Problem Type | Selection from the user defined table |
| Date Opened | Date the ticket for the Event was opened |
| Opened By | User that opened Event |
| Crew Assigned | Selection from the user name table |
| Customer | Selection from the user name table |
| Service Rep | |
| (CSR) | |
| Assigned | |
| Schedule Date | Date the event work is scheduled to start |
| Date Closed | Date the ticket for the Event was closed |
| Incident # | Incident number assigned to Event |
| P.O. Number | P.O. number assigned to Event |
| Estimated | Estimated charge |
| Charge | |
| Final Charge | Final charge |
| Work Done | Selection from the user defined table |
| ATM | The Event may or may not have an ATM |
| Information | associated with it. If an ATM is selected |
| (Optional) | for the |
| | Event, these fields provide information |
| | about the ATM. The ATM related fields |
| | cannot be changed on this form. |
| Partner | The Event may or may not have a Partner |
| Information | associated with it. If a Partner is selected |
| (Optional) | for the |
| | Event, these fields provide information |
| | about the Partner. The Partner related |
| | fields cannot be changed on this form. |
| Event | Description of the purpose of this Event |
| Description | |

The Event header information is followed by a series of notes. Any number of notes can be associated with an Event. The notes are kept by the system in reverse chronological order, with the most recent note showing at the top of the list. To add a new note, go to the end of list of notes and make an entry in the next available line.

There are restrictions on the editing of past Event notes. When a user tries to edit an older note, the system checks his or her security level. If the user has a security level of 0 or 1, edits are allowed. All users with a security level that is greater than 1 are not allowed to change older event notes.

Notes Fields:

| Name | Location | Description |
|---|---|---|
| Date | Tab 8 | The activity date for the note |
| | | (e.g., the date the ATM |
| | | experienced problems) |
| Type | Tab 8 | The type or category of note |
| Next Contact | Tab 8 | The date scheduled for the next |
| | | contact |
| Added | Tab 8 | The date the note was added to |
| | | the system |
| Last Change | Tab 8 | The date the note was last |
| | | updated or changed |
| By | Tab 8 | The user who is logged into the |
| | | system at the time the note is |
| | | entered |
| Notes | Tab 8 | A description of the reason for |
| | | the note |

The zoom button is available in the note section of the Events Module:

To use this feature, click anywhere inside the note to be viewed and then click the zoom button. The note will be opened in a separate form to provide the user with a better view:

Changes and updates to notes can be made in full view and will take effect when the form is closed. All restrictions on the editing of past notes also apply to the full view of a note.

When an event type is designated as “Litigation Matter”, the system adds another section to the Event Management Form. This section is called “Damages Calculation”. It uses historic data and ATM related data to provide the user with a damage cost estimate. This section is only visible when an event is a Litigation Matter:

Damages Fields:

| Name | Description |
|---|---|
| Yr/Mo | Identifies the year and month. |
| Txns | The number of total transactions per month |
| Vended | The total amount of withdrawals for the month |
| Revenue | The total revenue from all sources for the month |
| Expenses | The total expenses from all sources for the month |
| Profit | The net profit contribution for the month |
| Total Profit | The total profit contribution from the contract start |
| (Lifetime) | to date |
| Average Profit/ | The average profit contribution per month |
| Month | |
| Contract Months | The number of months remaining on the customer |
| Remaining | contract |
| Damages | The average profit contribution times the number |
| Calculation | of months remaining on the contract |

The print options for “Litigation” type events includes a feature that when a Litigation event is displayed and the “Print Event” button is pressed, a prompt is displayed with the following print options:

Current Litigation Event: generates a litigation report for the currently displayed event

All Litigation Events By Number: generates a litigation report for all open litigation events and sorts the report by Event ID

All Litigation Events By Location: generates a litigation report for all open litigation events and sorts the report by Location

A “flag” has been added to the upper right side of the Event form. If the current event is not a litigation event but the involved ATM has an open litigation, a red box with the word “Litigation” is displayed.

The system has two locations from which a new event may be generated. The first is through the Event form. The second is through the “ATMs With No Transactions” form described later in this section).

To add a new order from the Event form, click the add button located at the top of the form. A blank event order form will be displayed. Default data of today's date and status of “Open” are displayed. These defaults may be changed as necessary.

There are several combo boxes located on the form to assist the users in entering the data. The status, event type, CSR, and Crew boxes draw information that has been set up in System Configuration while the ATM and Partner related data is derived from the ATM and Partner screens respectively. The event form should be filled in as completely as possible.

The event description is meant to hold the main reason why the event was generated. The notes section is a way of recording subsequent actions in response to that main event. Notes are entered on this form and displayed chronologically by the last note entered. The system is also equipped with a “tickler” process. If a future date is entered into the system under “Next Contact”, the system can display a reminder to the user about that date.

New notes may be added to an existing event at any time. To add a new note, click anywhere in the notes section of the form. Use the notes scroll bar to scroll down to the and of the notes. Following the last record, there is a blank note with an asterisk (*). A new note can be recorded in this blank area.

Deleting Notes: the system does not allow an existing note to be deleted. Once the users leave the “note” area, the note is recorded and cannot be deleted.

When the users first enter the event forms, all events in the database are listed. The event order form is equipped with a Search Criteria box. This box allows the user to search by ATM, by Event ID, or use an extended search form. When the user chooses an ATM or a Partner, all events relating to that ATM or Partner will be displayed. The “filtered” records that met the criteria can be viewed by using the navigation buttons located at the bottom of the screen. The user can also return to the default view of all records by clicking the “Show All” button.

The event form is also equipped with an extended search capability that is activated by pressing the binoculars button. When the binoculars button is pressed, the following search criteria form is opened:

This form is set up so that more than one item may be used as selection criteria at any time. When more than one field is selected, the system will search for any events that match all the selected criteria. (e.g., if the first criteria selected is “Open” under “Status” and the second is “NY” under “State”, the system will find all events that are open and related to an ATM located in New York.).

This form is also set up so that certain fields allow “Search Strings”. “Search Strings” are searches that allow wildcard characters in the search. (For a list of the wildcard characters, please refer to Section 2.5 of the manual).

To search using the Search Criteria form, choose the criteria by which the users would like the system to search by following the guidelines above. After the users have chosen the appropriate criteria, click the “Search” button. The system will close the Search Criteria form and display the form from which the users launched the search. This “launch” form will only display the records that met the criteria of the usersr search. Use the navigation buttons at the bottom of the form to move from record to record. The criteria of the search will be displayed in the “Criteria” field located at the top of the form. To cancel the search and once again display all records, click the “Show All”.

To print a report of the Search Criteria, choose the criteria for the search described in detail previously). Once the criteria has been displayed, click the criteria report button and a report will be generated based on the current criteria.

To reset the criteria on the search criteria form, click the Reset button. All the fields on the form will return to blanks. The users may also cancel/close the search criteria form and no filter will be applied.

An event may involve an ATM, a Partner or both. To “attach” or relate an event to a particular ATM, choose the ATM from the Terminal ID, Location or Address combo boxes on the event form.

An event may involve an ATM, a Partner or both. To “attach” or relate an event to a particular Partner, choose the Partner from Partner combo box on the event form.

There are certain restrictions involving a users ability to edit event notes. Any user can edit a note on the day the note was created. However, only users with a security level of 0 or 1 can edit notes from previous days.

To print the current event, make sure the event is the current, displayed record and press the “print event” button at the top of the form. The system will display a preview report of the event. The user may then print the report.

To print an inactive report on a terminal, make sure an event that is related to the terminal is the current, displayed record and press the “Inactive Report” button at the top of the form. The system will display a preview report of the event. The user may then print the report.

The system has a feature that will assist the users in identifying any problems that may exist with specific ATMs. This feature provides the user with a list of terminals that were not included in an import file or were included but had zero withdrawals transactions listed. To access this feature, press the “ATMs With No Txns” button on the main menu. The users will be prompted to enter a range of dates for the search and then the system will display the following form:

The following are several areas on this form that may be of interest to the user:

The most recent date with WD transactions on file and the most recent date with any transactions on file. The average number of WD transactions on file for each terminal

If there are events already on file for the ATM (either Service Order events or other). To view the details on events already on file for the ATM, double-click on the “Yes”.

This form also offers the user the option to generate a new event. To generate a new event from this screen, click on the button next to the terminal under “Open New Event”. When this button is pressed the system will open the Events module and set up a new event for the ATM.

A user can call up the last note recorded for an ATM by clicking the button under the “Last ATM Note” column.

A preferred embodiment of the invention implementing the foregoing and other features of the invention described herein is written with the front-end business logic and graphical user interface implemented in the Microsoft Access database management system using Access queries, forms, reports and Visual Basic code, and the back-end integrated relational database implemented in either Microsoft Access or Microsoft SQL Server utilizing stored procedures. In order to take advantage of advanced client-server architectures where a portion of the application is installed once on the server, to allow connection to other database management systems such as SQL Server, and to enter the multi-user ASP Internet environment, the product may be re-written using a different set of development tools. Both the in-house version and the Internet version can co-exist.

The above described system provides the following features to address the key problem areas in operating and managing ATMs and scrip terminals:

It produces a comprehensive integrated relational database:

It develops a database of all key terminal data and relationships including: terminal configuration, location, vendor, model, cash capacity, maintenance service, armored car service, owner, partner, and other user-defined parties.

It collects and retains an unlimited history of daily transactions.

It makes this data useful by gathering and organizing it into stratifications by each terminal or by any grouping of the user's choice.

It automates the input of all terminal transaction data:

Import utilities are available to automatically read and store data from each transaction processor.

This automation dramatically reduces labor and transcription errors.

Audit routines insure all data has been collected. Missing data is identified. Late arriving adjustments are easily entered.

It manages ATM cash from the “ATM View” by:

Monitoring terminal cash balances and withdrawal rates.

Predicting when cash will run out.

Managing cash orders and cash replenishment schedules.

Managing armored car orders and cash movement including cash in-transit, and cash returns.

It manages ATM cash from the “Cash Provider View” by:

Reconciling all cash orders, cash deliveries, and cash movement through multiple correspondent accounts.

Reconciling total daily withdrawals to processor settlement amounts.

Reporting on daily terminal cash positions in all locations.

Calculating interest charges based on defined formulas.

Reconciling daily balances to in-house ledgers and journals.

Organizing all cash transactions to any user-defined group levels.

It manages all partner relationships by:

Developing extensive information about each partner.

Cataloguing all terminal /partner contractual terms and conditions.

Calculating all monthly income and expense components.

Producing monthly statements for overall terminal performance and for each partner's interests.

It provides a full reporting system that:

Provides extensive management visibility into revenue and costs of terminal operations.

Maintains an unlimited history of terminal balances, cash orders, cash replenishments, and transaction withdrawals.

Provides performance analysis of armored car services.

Provides charts and reports of daily cash activities to better understand traffic patterns and profitability.

Ranks terminals by transaction rates, by transaction amounts and by profitability.

Produces accounting statements for all partners.

Produces reporting by any group of terminals (by branch, location, etc.).

A preferred embodiment of the invention runs on PCs using Windows95 or higher. If a user's office PCs are networked, the database of the present invention is sharable from all PCs in the network.

Improving Cash Management Information Flow:

Much of the information exchange today among ISOs, cash suppliers and armored car companies is still in inefficient hard copy form. An ISO prepares a cash order for a group of ATMs and faxes it to the cash supplier. The cash supplier then reenters the order in its own record keeping system, produces another form of the order, and faxes it to the armored car company as delivery instructions. For each cash delivery, the armored car company faxes an account of delivery to both the cash supplier and the ISO, who must manually enter it back into its own record keeping systems. A companion product to the present invention will be developed to replace this hard copy information exchange. The software will be enhanced to export the cash order from the ISO and import it into the cash supplier's database, to export the delivery instructions from the cash supplier and import them into the armored car company's database, and to export delivery results from the armored car company's database and import them into both the ISO's and cash supplier's database.

Managing Delivery of Non-Cash Products from ATMs:

The products and services available from ATM and scrip terminals machines are expanding beyond cash and cash chits to include stamps, phone cards, tickets and coupons. The present invention currently supports such extended operations.

Managing Services of All Card-Based Self Service Kiosks:

Kiosks issue items of value, some for a customer cost and some for free. Kiosks of all types are appearing in more and more locations. Any chargeable items issued by a kiosk can be supported in much the same manner as ATM machines. Even kiosks that issue free items likely require the computation of various fees and expenses such as site fees, maintenance fees and advertising income. The terms and accounting module of the present invention is already engineered to address this emerging market.

Managing the Maintenance Function of ATMs and Kiosks:

All ATMs, scrip terminals and self-service kiosks have working parts and need both regular and emergency maintenance. Maintenance contracts and service calls are an expensive component of terminal operations. A maintenance and work order system appears to be a needed add-on component of the present invention. The present invention is well suited to support and assist a maintenance system because the present invention can already determine from the daily imported processor transaction files the number of jams, mis-feeds, over or short dispenses, out-of-cash shutdowns, and the like occurring at a terminal, and alert the user of needed maintenance.

Managing “Real Time” Customer Support:

Operators of ATMs often receive inquiries and complaints from customers who didn't get all their money, or have some other objection. In order to respond, the operators need to view the actual individual processor transaction records which contain completion codes, reversal codes, denial codes, mis-feed information and other data. Since the processor transaction files are downloaded each day and accumulated by terminal into the system, these files are retained in an accessible form on the user's computer for analysis. A transaction viewer module may be used to give users rapid visibility to any transaction on a formatted screen, so that the inquiry can be addressed while a customer is still on the phone.

Managing Customer Disputes:

Even after viewing a questioned transaction and talking with the customer, the customer may still dispute the result. A “file” must be opened for the dispute, information recorded and perhaps a variety of records researched and opinions or decisions reached. Temporary credits are sometimes issued and must be finalized or reversed. A dispute management system can be developed as an additional integrated component of the ATM management system.

Managing Interchange Fees:

Many banks issue credit or debit cards that may be used in ATMs worldwide subject to the cardholder paying the local ATM surcharge fee. In addition to the surcharge fee, the bank issuing the card is charged an interchange fee by the bank owning the ATM at which the card was used. At this time, banks appear to have no efficient means to analyze interchange fees so that they can determine, for example, which of their own cards are costing them the most money or where they are being used (geographically or kinds of establishments). The design of the present invention can be extended to optionally keep transactions at the cardholder level in addition to the terminal level, allowing extensive analysis of individual cardholder habits and patterns. Interchange fees also apply to scrip terminals. The additional module might open up a whole new market for card issuer cost control and user analysis.

The invention allows an opportunity to operate an ASP site that provides an Internet-based web-enabled version of The system, capturing ATM transactions, cash orders, cash replenishments and the like once for all parties concerned with the ATM. This opportunity arises from the fact that several users of the product may need to capture and analyze the same data. Consider the common example of an ISO renting its cash from a bank. Both the ISO and the bank are interested in the operations of the ATM, the ISO for cash ordering and all income and expense items, and the bank because it must keep track of its own cash in the ATM. They both download the same daily activity file from the processor, and they both track cash orders and replenishments. Additionally, experience has proven that two separate databases attempting to keep track of the same information seldom have exactly the same information.

An ASP site establishes one large scale database into which the processor transaction files, the cash ordering activities, the armored car replenishment activities, and all contractual terms and conditions will be managed for the benefit of all interested parties. With proper security individual users will only see and/or update information for which they are authorized. This development also places the present invention in the position of being a “Third-Party Data Broker,” a potentially commanding position in this industry.

The ASP site has attractive to the smaller deployers of ATMs as well as deployers who do not care to or cannot afford to acquire their own in-house version of the software.

The ASP approach would have the benefit of reducing business costs for all parties involved, and still improve data timeliness and accuracy. Further, and most importantly, in this line of business the present invention involves custody of a potentially massive database that can be sanitized and sold as marketing research data to an unlimited number of customers, as well as be the base of a premium-priced consulting service.

Selected features and benefits of the most recent release:

| Feature | Benefit |
|---|---|
| Terminals and Transaction | |
| Activity Module: | |
| ATM fields | Allows the definition of additional terminal types, |
| | merchant share information and how to apply cash loads |
| ATM Wizard | Leads user through the addition of new ATMs, |
| | prompting for required and preferred information |
| ATM bank account information | Documents the bank account numbers used for |
| | withdrawal, surcharge and interchange deposits |
| Prevention of closing terminals | Ensures the integrity of certain consolidated statements |
| with cash balances | |
| Processor import file screen | Only the user's processor names appear, eliminating the |
| streamlined | full list of available processors previously displayed |
| Processor file capture summary | Many users do not print the optional detailed processor |
| report now printed | import file capture report. A one page summary is now |
| | printed in all cases, documenting the totals of the |
| | capture process |
| ATM Group screen revised | Easier access to group level information |
| Terms and Accounting Module: | |
| Group level terms supported | Dramatically reduces the number of terms lines |
| | required, as group level terms apply to all terminals in |
| | the group. Also, significantly reduces work to change |
| | terms |
| Income and expense allocations | Both computed and manually entered amounts can be |
| supported | allocated automatically by several different methods to |
| | all terminals in a group |
| Table names verified when | Eliminates chance of misspelling a table name. Also, a |
| entered on terms lines | hot key is provided to view table information while |
| | working in the terms screen |
| Summary capability in terms lines | Allows a single reference that adds together the amounts |
| | of a set of terms lines, easing the ability to pay based on |
| | the net total of several lines |
| Catalog of report distribution | New ability to catalog the reports sent to partners, |
| cycles | including how and on what schedule they are sent. |
| Further Partner fields | Allows the definition of payment methods, bank account |
| | types, interest information, and new memo capabilities |
| Further profit report for an ATM | Allows the comparison of profit contributions among |
| Group | ATM groups |
| Further ability to print statements | Packages reports by partner group so that a designated |
| for all members of a Partner | partner receives a package of the reports for each |
| Group | individual partner in the group |
| Cash Management Module: | |
| Ability to make changes to posted | Avoids need to make adjustments to posted orders via |
| Cash Orders | additional orders. Also, includes the ability to add and |
| | delete order lines to posted orders |
| Ability to make changes to posted | Allows changes to any field associated with a posted |
| Cash Loads (Replenishments) | Cash Load. Also, includes the ability to delete a posted |
| | Cash Load, returning the load to a memo posted open |
| | order status. |
| Assistance in building new Cash | For all new terminal cash order lines, the courier pickup |
| Orders | date and the fill date are now supplied, assisting in |
| | building the order |
| Capabilities in computing the | Cash loads may be treated as happening at begin of day, |
| effect of cash loads | mid day or end of day, by terminal if desired, to more |
| | closely approximate the end of day cash balance in a |
| | terminal |
| Event Management Module: | |
| New Event fields | Allows documentation of problem type and work done, |
| | expanding the capabilities of analyzing event attributes |
| Open Insurance Indicator added | Indicates when viewing an event for any terminal, |
| | whether there is an insurance event open for the same |
| | terminal. |
| “24 hour” monitoring screen | The ATMs with No Txns screen eliminates any ATMs |
| | from view that have an open litigation or insurance |
| | event, so that they do not mix with the monitoring |
| | function |
| System-wide Features: | |
| Search boxes added to several | Allows easier and quicker lookups of information |
| screens | |
| Customization of report formats | Ability to toggle on or off any data column of four |
| | different reports that are frequently sent to ISO, sub- |
| | ISOs, dealers, merchants and the like. The reports can |
| | now contain only the information that the users want |
| | others to see |
| Ability to e-mail reports | Ability to attach any system report to an e-mail and |
| | launch the e-mail client (e.g. MS Outlook) |
| system-wide monthly close | Allows a monthly close effect where no changes are |
| capability | permitted to statistical or accounting figures prior to the |
| | close date, protecting the integrity of numbers passed to |
| | other systems, such as general ledger and accounts |
| | payable |
| Error Handling | Manages several additional error conditions avoiding |
| | the need to cancel routines or answer system level |
| | questions |
| installation routine | An installation wizard minimizes the work to add the |
| | ATM management system to additional computers |
| Small, fast client program | Fast execution speed and elimination of non-essential |
| | toolbars from screens |

The initial display for the “ATM Groups” shows a single group, the terminals that are members of that group, and terms/allocation information associated with the group. There is a group selection combo box located on the top of the form for easy group navigation. A full list of groups can be viewed by choosing the “All Groups—Screen Report” option and clicking “Execute”.

Many users are unsure of what information is necessary when adding a new terminal to the database. An ATM Setup wizard has been added to the ATM screen that leads the user through a complete set of setup screens for each ATM. Clicking the “Add” button on the ATM Terminals screen will launch this wizard:

This ATM wizard takes a user through a series of questions and on-screen instructions that assist in the setting up of a new terminal. All required fields are on the first panel of the Wizard.

Cash Settlement Tab on ATM Screen Revised:

The Cash Settlement tab on the ATM Screen includes two sections:

Top Section:

The purpose of this section is to store and track information relating to the bank accounts to which interchange fees, surcharge fees, and withdrawal amounts are deposited.

Bottom Section:

The bottom section of the screen identifies which (if any) Settlement Float table an ATM uses. Settlement Float tables identify when withdrawn cash and surcharge amounts settle back to the usersr bank accounts. This display has been changed so that it now shows the settlement day of the week for each daily processor transaction file.

The following fields also appear on the ATM screen:

Terminal Type (Located on the Main Screen)

This combo box provides the user with a way to categorize terminals (e.g., ATM, POS, etc.) This is a user-defined table of values. The types of terminals available to the system can be set up in System Configuration (Code Tables tab, “ATM Terminal Types” button).

Est Mrch Share (Located on the “Information” Tab)

An estimated merchant share of the surcharge.

Apply Load (Located on the “Replnsmnt” Tab)

How cash loads should be treated by the system: BOD (beginning of day), EOD (end of day), or MID (middle of day). If this field is left blank, the system-wide setting will be used (located in System Configuration on the “Parameters” tab). If the System Configuration setting is blank, the default is BOD. Prior to this release all cash loads were treated as happening at the beginning of the processor's settlement day. Note: the ATM setting takes precedence over the system setting. (For further details, please refer to the Cash Management section of this bulletin).

The system will not allow the status of an ATM to be changed to “Closed” if the ATM has a cash balance on file. Only ATMs with a zero cash balance in the ATM cash field can be designated as “Closed”. Additional status codes such as “Pending” or “Closed Pending” can be used until the balance has been removed from the terminal. This new feature keeps ATMs from being closed and disappearing from certain forms and reports, when they still have cash in them. Note: An ATM can be closed if it has a zero ATM cash balance, but still has an accumulated over or short condition resulting in a non-zero remaining cash liability.

The navigation on the ATM Daily Transaction Statistics and ATM Monthly Transactions Totals screens have been improved. Combo box selections are now available to allow easier access to terminal information.

Re the “Import” screen. A Combo box selection has replaced the radio buttons that list the system's import types. In addition, the system has been updated so that it will print import capture and import posting errors. The error report will print even if the reporting options for these two reports have been turned off. In addition, a totals line for transaction counts and amounts will always be printed for each file captured, so that the totals can be retained, referenced, and compared to any processor reports provided.

Under the structure of the system's terms and accounting, in addition to defining terms at the individual ATM level, terms can now be defined at the ATM Group level, and all ATMs in the group will inherit those terms lines. This feature dramatically reduces the number of terms lines required in many instances, and additionally reduces the time and effort to change terms lines.

Terms can now be defined in one of four separate categories:

ATM Specific Terms:

ATM Specific Terms are terms set up for an individual ATM on the ATM Terms screen.

The ATM Terms screen has three tabs. The first tab displays each ATM's specific terms and any (new) group level terms (noted with a “G”). This tab is for display purposes only and cannot be edited. The second tab shows all the ATM Specific terms that have been set up for the terminal. This is the tab where ATM Specific terms can be added or edited. The final tab displays all the ATM's new group related terms. The third tab cannot be edited. However, the group terms definition section can be accessed by double-clicking on the appropriate group name on the tab.

The navigation on the ATM Terms screen has a combo box selection to allow easier access to terminal information.

Group Level Terms:

Group Terms are terms lines set up using ATM Groups, and apply to each ATM in the group in the same manner as if they were set up at the individual ATM level for each ATM in the group. The “Group Terms” tab is located on ATM Groups form (accessed through the main menu).

New group level terms can be added directly to this tab. As existing group terms are edited and new lines added for a group, the change is immediately applied to all terminals within the group. In addition, as new terminals are added to existing groups, all the lines that have been set up for that group automatically become part of the new ATM's terms.

Group Terms function in the same way as ATM Specific Terms. They have the same data requirements (e.g., unique line numbers, required fields, etc.). The system simply takes the term line and applies it to all ATMs in the group. For example, suppose a computed line, L100+L110, is set up at the group level. Each ATM in the group will have an accounting display that includes a sum of that ATM's line 100 and line 110 for each applicable month.

Group Terms are added immediately to each ATM in a group. However, monthly accounting is not automatically generated. Like ATM Specific Terms, Group Terms require a computation process. This can be done for all levels of terms and groups by clicking the “Recompute All Monthly Accounting” button on the Calculations menu. To see accounting results on individual ATMs in a group, the “Show Acctng” button on an ATM's Terms screen or the “Recalc Acctng” on an ATM's Accounting screen can be pressed.

Group Allocation Terms:

Group Allocation Terms are group terms where a total is generated for the ATMs in the group, and then distributed back to the ATMs in the group based on a selected allocation method. The allocation methods currently supported by the system are as follows: a) total withdrawal, interchange or surcharge amounts, b) volume of several types of transactions, or c) even distribution of an amount to all ATMs in the group.

Group Allocation Terms are set up in the same way as other group terms. A Group Allocation Term is defined when an allocation method is chosen for that term from the combo box under the “Allocation Method” column:

Group Allocation Terms are different from Simple Group Terms. Terms involving allocations calculate a total for the ATMs in the group, and then distribute that total back to each ATM on a selected pro-rata basis.

Group Allocation Terms can be set up in the same way as ATM Specific Terms and Simple Group Terms. The only exception is that a group total cannot be generated for a Base Type of “Comptd” or “Prime”. For example, suppose a distributor is paid based on the total transactions for a group of ATMs each month, rather than the transactions of each ATM individually. This computation requires the ATM management system to add up the total transactions for a group or ATMs, and generate an expense amount that is dependent on cost brackets for different volumes in a table. Once the expense amount is generated, the amount needs to be distributed back to each ATM in the group based on their pro-rata share of the transactions. A terms line to handle this situation, would be developed as follows:

Step 1: Create a table that matches the volume needs of the contract for total transactions e.g.:

| | High | |
|---|---|---|
| Low Limit | Limit | Value |
| 1 | 20000 | 0.50 |
| 20001 | 40000 | 0.60 |
| 40001 | 80000 | 0.70 |
| 80001 | 99999 | 0.80 |

Step 2: Add a group level terms line (e.g., line number, expense vs. income, partner name, minimum amount, etc.). In this instance, Base would be “Tt1Txn”, Frequency would be “Table”, Equation would be the name of the group table created in Step 1 and the allocation method would be “Tt1Txn”.

Group Allocation Terms are added immediately to each ATM in a group. However, monthly accounting is not automatically generated. Like ATM Specific Terms and Simple Group Terms, Group Allocation Terms require a computation. (Re)calculations for all terms at all levels is done by clicking the “Recompute All Monthly Accounting” button on the Calculations menu. To perform the calculation for an individual group, click the “Calculate and Distribute Allocation” button located on the “Group Terms” tab.

The “Group Allocations” tab shows the detail of how a total charge was distributed back to each ATM in the group. The tab displays the total amount computed in the terms line for each month:

To view a breakdown of how a month's Computed Amount was distributed among the ATMs in the group, double-click on the group terms line. The following pop-up screen will be displayed showing each ATM in the group and its dollar and percentage share of the total amount:

Allocation Terms—Manual Entries:

Group Allocation Terms—Manual Entries are group allocations where an amount is entered by the user for a month and then distributed by the system to all ATMs in the group. As an example, a manual entry is required when a bill is received that must be allocated in some fashion to each ATM in a group. Manual Entries are setup like other group terms. The only difference is that “Manual” is selected as a Base and text such as “To Be Determined” is entered in the Equation field. When monthly accounting calculations for Group Allocation Terms are computed (described above), the system generates a zero amount for manual terms for each applicable month's accounting statement:

This acts as a placeholder for the actual amount. The amount can be entered by the user at the group level, and subsequently distributed to the ATMs in the group. When a manual amount has been entered, it can be distributed to all the ATMs in the system by clicking the “Distribute Manual Entries” button located on the Group Allocations tab. [Note: entered manual amounts are also distributed/re-distributed to ATMs through the Group Allocation Terms monthly calculations as described above.]

Since the proper application of group terms is dependent on ATM Groups, it is important to keep the ATMs in the groups up-to-date. ATMs should not be deleted from groups. Instead, start and end dates should be used to manage a terminal's participation in a group. Note that the start and end date of an ATM's participation in a group is in addition to the start and end date of the terms line itself. Both come into play in determining if and when to apply a group term line to a particular ATM.

As a user adds or edits a terms line, the line is checked to verify it meets certain criteria (i.e., unique line number). A new check is added to this validation. When a table is used in a terms line, the system now verifies that the table exists. A hot key combination (Control/R) allows immediate lookup of table names for use in these lines.

By placing a colon between two line number references in the terms line equation column (e.g., L3:L10), the System will add up the values for all the line numbers between the colon references. For example, L2:L5 will result in L2+L3+L4+L5. Any line numbers that do not exist or are not active will be ignored.

A “Statement” tab on the Partner Screen can be used to assist the user in documenting the system reports/statements that are sent to the Partner, including the frequency and method by which they are sent. In this release, this information is for documentation purposes only, to know from one month to the next which reports the users have decided to send to individual partners. However, it forms the base on which more automatic report producing services will be provided in the future.

The following fields have been added to the Partner screen:

Payment Method (Located on the “Information” Tab)

This combo box provides the user with a way to designate whether the Partner uses an ACH or check payment method.

Bank Account Type (Located on the “Bank Accounts” Tab)

This combo box provides the user with a way to designate the type of bank account (e.g., DDA account).

Compute Interest (Located on the “Bank Accounts” Tab)

This check box provides the user with a way to designate if the account is in an interest bearing account.

Interest Rate from Prime (Located on the “Bank Accounts” Tab)

This field provides the user with a way to designate the interest rate for the account.

Partner Memo (Located on the “Notes” Tab)

Similar to the ATM memo field, this Partner new memo field appears on certain forms and reports a sort of constant visible note. It is used to indicate important information such as the hours of operation of the merchant store.

Copying of Terms Lines Revised:

The procedure that copies terms lines from another ATM includes any copied line numbers that already exist in the target ATM, but drops their line numbers. The user can fill in these line numbers after the copying is complete, or delete the lines, whichever is appropriate. Note: Terms lines must have unique line numbers or the system will not compute monthly accounting accurately.

The navigation on the ATM Accounting screen has a drop-down menu e to allow easier access to terminal information.

The Table screen includes an “Add” button.

Cash Order Needs Form and Report Now Available by ATM Group:

The Cash Order Needs screen and report prompt for a group name, so that only those non-closed ATMs for which the Monitor Cash check box is checked will be displayed. This allows easier replenishment needs analysis for an individual group of ATMs. The full list of ATMs can still be displayed by leaving the group name blank when prompted.

Another feature in the ATM management system is the ability to edit both the main and detail sections of posted Cash Orders. There is now an edit button located in both sections that will start the edit feature:

Editing the Detail Line of a Cash Order:

To edit the detail line of a cash order, click the edit button located on the line. The following screen will be displayed:

Any changes to the detail line can be made directly to this screen. Once all changes have been made, click the “Save Changes” button. The system will analyze the changes. If any errors are encountered (e.g., amount ordered does not match number of bills), the system will report the error and the changes will not be saved. If no errors are found the changes are saved to the order. Note: If the amount ordered has changed, the system will automatically adjust the total amount of the order.

To remove a terminal from a cash order, click the “Delete” button. A message will be displayed asking for confirmation. If “Yes” is selected, the terminal will be deleted and the total of the order updated. If “No” is selected, the terminal is not deleted.

To leave form without saving changes, click the “Cancel” button. The form will close and no changes will be saved.

Editing the Main Section of a Cash Order:

To edit the main information of a cash order, click the edit button located in the top section of the cash order screen. The following screen will be displayed:

Changes to a Cash Order can be made directly to this screen, with the exception of fields with a gray background. Once all changes have been made, click the “Save Changes” button. The system will analyze the changes. If any errors are encountered, the system will report the error and the changes will not be saved. If no errors are found the changes are saved to the order. Note: The total amount of an order cannot be changed on this screen. However, the amount will be adjusted by the system if changes are made to the amount of an order detail line, or if detail lines are added or deleted.

To leave form without saving changes, click the “Cancel” button. The form will close and no changes will be saved.

Estimate of Need Date/Pickup Date Now Placed on Cash Order Detail Line:

When a terminal is selected for a cash order, the system fills in a series of defaults (e.g., amount ordered, number of bills, etc.). An estimated Need (or Fill) Date and Pickup Date are provided for the defaults that will be supplied.

Feature Allowing Changes to Cash Loads has been Expanded:

Cash loads can be changed on the Cash Loads By ATM screen (accessed from the Cash Loads Screen). Changing a cash load now is done in a way that is similar to changing a cash order. The Cash Loads By ATM screen has an Edit button.

Changes to a Cash Load can be made directly to this screen, with the exception of fields with a gray background. Once all changes have been made, click the “Save Changes” button. The system will analyze the changes. If any errors are encountered, the system will report the error and the changes will not be saved. If no errors are found the changes are saved to the order.

To leave form without saving changes, click the “Cancel” button. The form will close and no changes will be saved.

To delete a cash load, click the “Delete” button. A message will be displayed asking for confirmation. If “Yes” is selected, the cash load will be deleted and the status of the load returned to pending status (it is then again considered an open, pending order for the ATM). If “No” is selected, the cash load is not deleted.

When posting a cash load, the system will check if the load date is within (plus or minus) three days of the need date. If the date is outside of this time frame, a warning message is displayed, with the option to return to the form and correct the date before posting i

It is possible to view the Partner Details for a Cash Account. When the Partner Name field is double-clicked, the system opens the Partner screen and displays the information for the Partner to which the account is related.

A cash load can be set by the user to be applied at the beginning of the processor settlement day, the middle of the processor settlement day, or the end of the processor settlement day. This feature affects the estimated cash balance used for cash forecasting purposes:

Beginning of Day (BOD): this feature applies all withdrawals for a processor settlement day as happening after any loads for that same day. This results in the lowest or “safest” estimated cash balance for the ATM.

End of Day (EOD): some processors offer the option of pushing all transactions after a load to the next day's settlement file. If the usersr processor does this, selection of EOD will allow a solid reconciliation in the ATM Management system reports with the processor reports.

Middle of Day (MID): the MID value assumes the load happened in the middle of the processor's business day and may be the best overall, system-wide choice for most users.

How a cash load is applied can be set on a system level or individual ATM level.

If the cash loads are applied in the same way for all or a majority of the ATMs, the system setting can be used. The system setting can be accessed through the “Parameters” tab in System Configuration. The “When to Apply Cash Load” combo box can be set to BOD beginning of day), MID (middle of day) or EOD (end of day). The system level setting will be applied to all ATMs that have no individual setting.

If cash loads need to be applied uniquely for certain ATMs, the individual ATM setting can be used. The individual setting is located in the ATM Terminals screen on the “Replnsmnt” tab (“Apply Load”). The ATM's individual setting takes precedence over any system settings. (e.g., if the system is set to BOD and Terminal “Sample” is set to EOD, cash loads will be applied at the beginning of day for all ATMs except for “Sample.” All cash loads for “Sample” will be applied at the end of the day.

Events Module

Event Management Tracking Improved:

Event Management has been expanded to include two new fields: Problem Type and Work Done. These are user-defined fields that can be used to categorize problems and work done. Both of these fields can be set up through System Configuration on the “Code Tables” tab.

“Open Insurance” Indicator Added to Events:

A “flag” is provided on the the Event form. If the current event is not an insurance event but the involved ATM has an open insurance event, a red box with the word “Open Insurance Event” is displayed.

ATMs with No Transactions Report Revised:

The screen report “ATM's With No Transactions Reported” does not include any terminals that already have open insurance or litigation events.

System Configuration

An “Accounting Cutoff Date” Feature has been Added to System:

It is possible to freeze or perform a close operation on prior months in the ATM management system. When used, this feature will not allow any recalculations, data entry or any other data revisions prior to a date set by the user. In this manner, statistics and amounts published in reports or passed to other accounting systems will not be allowed to change, and any attempt to add or change data to the system that would cause such a change will be refused. Any necessary adjustments can then be made in the current period.

The cutoff date is set in System Configuration on the Parameters tab. Any changes in the following areas will be checked to be sure they have no effect prior to the Accounting Cutoff Date:

Daily Import Transactions additions, deletions and changes

ATM Terms additions, deletions and changes

ATM Groups additions, deletions and changes

ATM Group Terms additions, deletions and changes

Cash Settlement Table additions, deletions and changes

Settlement Float Table additions, deletions and changes

Cash Order additions, deletions and changes

Cash Load additions, deletions and changes

Cash Transfer additions, deletions and changes

It is possible to customize four different printed reports that contain columns of statistical and income amount data, so that they only display the information that the users want. The four reports are the:

ATM Daily Transaction Detail Report,

ATM Daily Activity Summary,

Partner ATM Txn Activity Statement, and the

Partner ATM Monthly Statement.

These four reports are commonly sent to others such as investors, ISOs, sub-ISOs, distributors, dealers, and merchants. In this release, additional columns of data have been added to these reports, and the ability to toggle on and off any of the columns the users wish. A new tab has been added to the system configuration screen to select which columns of data are to be contained in each report when it is printed. Using the check boxes provided, the users may customize each report to appear the way the users want when it is printed.

The look of the Import Directories Screen provides the user with the code (placed in the Imp/Export ID/XID field of the Partner screen) for each processor.

The ATM Monthly Profit Comparison Report has been expanded to include the profit contribution for each of the last three months, in addition to the average of all months on file.

The partner accounting reports that are available at the individual partner level are available at the partner group level as well. Selecting one of the reports at the partner group level will print the report for each member of the partner group, eliminating the need to select each of the partners individually and print the report. This “package” of reports may be sent as a whole to one location (e.g. a sub-ISO to provide information about each of its sites), or this feature may be used as an easy method of printing reports for each member of the group and each report sent separately to the member locations.

The “ATM Monthly Profit Comparison by Group” report lists the average profit per month alphabetically by group including a count of ATMs for each group. The report is time sensitive to when an ATM starts and ends participating in a group.

It is to be understood that the above-described embodiments are simply illustrative of the principles of the invention. Various and other modifications and changes may be made by those skilled in the art which will embody the principles of the invention and fall within the spirit and scope thereof.

Appendix A

The general fields of FIG. 3 are as follows:

| Name | Description |
|---|---|
| Terminal ID | User's ID for this terminal. Appears |
| | in many screens and reports to |
| | identify the terminal. Important: see |
| | illegal character list. |
| Location (Name) | Name of location or site where ATM |
| | is installed |
| Type | The types of terminals available to |
| | the system. Type can be set up in |
| | System Configuration (Code Tables |
| | tab, “ATM Terminal Types” button). |
| Status | ATM status (Code Tables tab, |
| | “ATM Status Codes” button) |

The general fields of FIG. 4 are:

| Name | Description |
|---|---|
| ATM Address | Street address line 1 of terminal |
| Line 1 | |
| ATM Address | Street address line 2 of terminal |
| Line 2 | |
| ATM City | City of terminal |
| ATM State | State of terminal |
| ATM Zip | Zip code of terminal |
| Country | Country of terminal |
| ATM Phone | ATM phone number |
| Contact | Name of contact for this terminal |
| | (e.g. owner or merchant) |
| Contact Phone | Contact phone number |
| Contact Fax | Contact FAX number |
| E-mail | Contact e-mail address |
| Owner | Owner of the ATM |
| Import/Export ID | Cross-reference ID for |
| | Importing/Exporting Data |
| Max WD | The maximum withdrawal amount |
| | allowed. |
| Terms Base | Are the accounting terms to be |
| | computed (settled) based on the |
| | “Counts On file” for the ATM or the |
| | “Processor Claim” amounts |
| | provided at period end? |
| Surcharge | The amount charged per surcharge |
| | transaction. |
| Sales Rep | Name of sales representative |
| Est Mrch Share | An estimated merchant share of the |
| | surcharge. Note: the amount entered |
| | in this field has no affect on terms |
| | lines involving surcharge amounts. |
| Installer | Name of person or company that |
| | installed ATM. |
| Mrch Guarantee | An amount guaranteed to merchant. |
| Internal Term ID | The systems internal number for |
| | tracking terminal. This number is |
| | assigned by system and cannot be |
| | changed. |
| Cust Contrct Start | The contract start date for Terminal |
| Cust Contrct End | The contract end date for Terminal |
| Arrangement | ATM deal or type of arrangement |
| | made with Partner. |
| Date Installed | Date the ATM was installed at the |
| | user site |
| Date De-Installed | Date the ATM was de-installed at |
| | the user site |
| Processor | Network processor that records the |
| | clearance and settlement ATM |
| | activity |
| Processor | ID by which the Processor identifies |
| Terminal ID | the ATM. May be different from |
| | above Terminal ID. Used to match |
| | records in processor download files. |
| Cutoff Time | Terminal settlement time |
| Serial Number | Terminal serial number |
| Manufacturer | Terminal vendor/manufacturer (from |
| | user defined code table) |
| Model | Terminal model (from user defined |
| | code table) |
| Dispenser | Terminal dispenser type (from user |
| | defined code table) |
| Free Paper | A check indicates that the ATM |
| | currently gets paper for no charge |

The fields of FIG. 5A are:

| Name | Description |
|---|---|
| Monitor Cash? | Check this box if the users manage cash for this |
| Cash Responsibility | ATM. |
| | Partner responsible for managing cash. |
| Cash Rented From | Partner from whom cash is rented. |
| Cash Rented | Cash account used for terminal. |
| Account | |
| Armored Car | Armored car service that replenishes ATM |
| Cash Return | Cash account used for returns. |
| Account | |
| Add or Swap | Is replenishment a Cash Add or Swap? |
| Cash Low Limit | Minimum amount of cash to keep in ATM, if not |
| | zero |
| GL Cost Center | General Ledger system cost account for costs |
| | associated with this ATM |
| Propose Order Using | Base default order amount on “Standard” or |
| | “Computed” figures. |
| Standard Load | Standard cash replenishment amount in dollars |
| Amount | |
| Number of 5s | Number of $5 dollar bills in standard |
| | replenishment |
| Number of 10s | Number of $10 dollar bills in standard |
| | replenishment |
| Number of 20s | Number of $20 dollar bills in standard |
| | replenishment |
| Number of 50s | Number of $50 dollar bills in standard |
| | replenishment |
| Number of 100s | Number of $100 dollar bills in standard |
| | replenishment |
| Order Lead Time | Lead time in days between placing order and |
| | replenishment date |
| Days to Order to | Number of days replenishment should cover |
| Cover | |
| Days to Pad Order | Number of extra days that should be included in |
| | cash order |

The fields of FIG. 5B are:

| Name | Description |
|---|---|
| Settlement Type | Cash, Surcharge, Interchange |
| Settlement | Account to which settlement type |
| Account Name | will be applied |
| Bank Name | Name of Bank Owning This |
| | Account |
| Start Date | Beginning effective date of |
| | settlement delay table for this ATM. |
| | (Note: if this field is left blank, the |
| | settlement start date will default to |
| | the first day of transactions.) |
| End Date | Ending effective date of settlement |
| | delay table for this ATM. (Note: if |
| | field is left blank, the settlement |
| | table will be in effect until an end |
| | date is entered.) |
| Settlement Float | Name of settlement delay table used |
| Table Name | for this ATM |
| Start Date | Date to start ATM in Group |
| End Date | Last date ATM is in Group |
| Sun Mon Tue | When settlement will be applied for |
| Wed Thurs Fri | a given day |
| Sat | |

The Fields of FIG. 5C are as follows:

| Name | Description |
|---|---|
| Armored Car | Armored car service that replenishes |
| | ATM |
| Replenishment | Desired replenishment cycle in effect |
| Cycle | for ATM from Arm Car Service (Daily, |
| | Weekly, Biweekly, Monthly) |
| Replenishment | Cycle Segment, e.g. “A” week or “B” |
| Segment | week for Biweekly Cycle. This is an |
| | optional setting for a Monthly |
| | Replenishment cycle. |
| Replenishment | The days of the week that the armored |
| Days | service will replenish this ATM |
| | without extra charges, or that the users |
| | wish to plan replenishments. |
| Regular Run | The cost for a regular armored car |
| | delivery |
| Special Run | The cost for a special armored car |
| | delivery |
| Apply Load | How cash loads should be treated by |
| | the system: BOD (beginning of day), |
| | EOD (end of day), or MID (middle of |
| | day). If this field is left blank, the |
| | system-wide setting will be used |
| | (located in System Configuration on |
| | the “Parameters” tab). If the System |
| | Configuration setting is blank, the |
| | default is BOD. Note: the ATM setting |
| | takes precedence over the system |
| | setting. |

The fields of FIG. 5D are:

| Name | Description |
|---|---|
| Date Shipped | Date the ATM was shipped form the |
| | manufacturer. Comes from the Master |
| | Serial Number record if ATM serial |
| | numbers are pre-registered. |
| Warranty Coverage | Manufacturer warranty coverage. |
| | Comes from the Master Serial Number |
| | record if ATM serial numbers are pre- |
| | registered. |
| Warranty Start Date | Date manufacturer warranty starts. |
| | Comes from the Master Serial Number |
| | record if ATM serial numbers are pre- |
| | registered. |
| Warranty End Date | Date manufacturer warranty ends. |
| | Comes from the Master Serial Number |
| | record if ATM serial numbers are pre- |
| | registered. |
| Warranty Cost | Manufacturer warranty cost, if any, |
| | including extensions. Comes from the |
| | Master Serial Number record if ATM |
| | serial numbers are pre-registered. |
| Date Installed | Date the ATM was installed at the |
| | user site |
| Date De-Installed | Date the ATM was de-installed at the |
| | user site |
| Customer Warranty | Warranty coverage plan given/sold to |
| Coverage | the customer |
| Customer Warranty | Date customer warranty starts |
| Start Date | |
| Customer Warranty | Date customer warranty ends |
| End Date | |
| Customer Warranty | Customer warranty cost, if any, |
| Cost | including extensions |

The fields of FIG. 5E are:

| Name | Description |
|---|---|
| Group | List of Groups in which this ATM |
| Name | participates. Used for various analysis |
| | and reporting purposes. |
| Description | Description of the Group |
| Start Date | Date ATM begins participation in the |
| | group. (Note: if no date is entered, the |
| | ATM is considered an active member of |
| | the group for as long as the group is |
| | active.) |
| End Date | Date ATM ends participation in the group. |
| | (Note: if no date is entered, the ATM |
| | remains a member of the group until an |
| | end date is entered.) |

The fields of FIG. 5F are:

| Name | Description |
|---|---|
| Numeric | Field will hold any numeric value |
| Currency | Field will hold any currency value |
| Text | Field will hold any text value |
| Date | Field will hold any date value |
| Check Box | Field will hold any yes/no value |

The fields of FIG. 5G are:

| Name | Description |
|---|---|
| Memo | The purpose of this field is to hold |
| | information on a machine that will |
| | appear in other areas of the system, |
| | (e.g., a memo could notify a user |
| | that the store where the ATM is |
| | located is closed on Sundays). |
| Date | The activity date for the note (e.g., |
| | the date the ATM experienced |
| | problems) |
| Type | The type or category of note |
| Next Contact | The date scheduled for the next |
| | contact |
| Added | The date the note was added to the |
| | system |
| Last Change | The date the note was last updated |
| | or changed |
| By | The user who entered the note |
| Notes | A description of the reason for the |
| | note |

The following table lists some of the screen reports available from data captured in the Terminals and Txn Activity. They can be located as follows:

| Screen | | |
|---|---|---|
| Report | Form (Location) | Purpose and Notes |
| Weekly | ATM Form and | Graphically compares the number |
| Withdrawal | Screen Reports: | of withdrawal transactions and |
| Statistics | Weekly | amounts for the last 8 weeks |
| Chart | Withdrawal | |
| | Statistics Charts | |
| Monthly | ATM Form and | Graphically compares the number |
| Withdrawal | Screen Reports: | of withdrawal transactions and |
| Statistics | Monthly | amounts for the last 9 months |
| Chart | Withdrawal | |
| | Statistics Charts | |
| Monthly ATM | Screen Reports: | Displays several statistical |
| Statistical | Monthly ATM | calculations per month, ranking |
| Comparisons | Statistical | terminals from the highest rate to |
| | Comparisons | the lowest |
| Check For | Audit Checks: | Displays a list of missing daily |
| Missing | Missing ATM Day | records that should be investigated. |
| Daily | Records | A daily record should be on file for |
| Records | | all dates on which the processor |
| | | issues a report. |
| Zero Txn | Audit Checks: | Displays a list of daily records for |
| Counts | ATMs With No | which the withdrawal amount is |
| | Transactions | zero. Helpful in determining if |
| | Reported | ATMs are out of cash or have a |
| | | maintenance problem. |
| Day of Week | Screen Reports: | Displays a list of the average |
| Charts | Daily Withdrawal | withdrawal amounts by the day of |
| | Statistics Chart | week. |
| Custom | Screen Reports: | Allows the user to generate custom |
| Listings | ATM Custom | ATM lists. |
| | Listing | |
| ATM | Audit Checks: | Compares the surcharge amount |
| Surcharge | ATM Surcharge | listed on the ATM screen with the |
| Variances | Variances | average surcharge amount from the |
| | | processor files. (Note: if no |
| | | surcharge has been entered on the |
| | | ATM screen for a terminal, no |
| | | comparison is made.) |

The following table lists the printed reports available based on the data in the Terminals and Txn Activity. Here's how to produce them:

| Report | Form | Purpose and Notes |
|---|---|---|
| ATM Master List-All | Printed Reports: | All data for each ATM |
| Data | ATM Master | |
| | List | |
| ATM Listing by | Printed Reports: | Short form. One line of data for |
| Terminal | ATM Listing by | each ATM. Ordered by Terminal. |
| | Terminal | |
| ATM Listing by | Printed Reports: | Short form. One line of data for |
| Location | ATM Listing by | each ATM. Ordered by Location. |
| | Location | |
| Monthly ATM | Printed Reports: | ATM's ranked by average |
| W'drawal Txn Rate | ATM WD Txn | monthly volume of withdrawal |
| Comparison | Rate Comparison | transactions over the last six |
| | | months |
| Monthly ATM | Printed Reports: | ATM's ranked by average |
| Withdrawal Amount | ATM WD Amt | monthly volume of withdrawal |
| Comparison | Comparison | amounts over the last six months |
| ATM Groups | Printed Reports: | ATM's located in a selected group |
| | ATM Groups | |
| Daily Txn Detail with | Printed Reports: | Lists daily activity counts for an |
| Charts | ATM Group | ATM for a month, with charts of |
| | Daily Activity | withdrawal activity and |
| | Summary | withdrawal amounts |
| | and ATM Form: | |
| | Daily Activity | |
| | Report | |
| Cash Settlement | Printed Reports: | Report that can provide transaction |
| Report | Cash Settlement Report | information by processor or group. |
| Daily Transaction | Daily Transaction Statistics: One | Lists daily activity counts for an |
| Detail | Month Report | ATM for one month |
| Daily Transaction | Daily Transaction | Lists a column for each month on file, |
| History Report | Statistics: Full History | showing the total withdrawal transactions |
| | Report | and amounts for each day |
| Monthly Transaction | Monthly Statistics: | Lists the two sets of monthly activity and |
| Summary | Monthly 12 Mo Report | dollar counts: one for the accumulation |
| | | of daily counts on file, and one for the |
| | | processor reported counts for the same |
| | | period |
| Average Withdrawal | Screen Reports: | ATM's ranked by monthly withdrawal |
| Txns | Monthly ATM Statistical | transaction rates. (Double-click on “Avg |
| | Comparisons | WD Txns” label and click “Print |
| | | Preview” for report.) |
| Average Withdrawal | Screen Reports: | ATM's ranked by monthly withdrawal |
| Amount | Monthly ATM Statistical | amounts. (Double-click on “Avg WD |
| | Comparisons | Amt” label and click “Print Preview” for |
| | | report.) |
| Average Surcharge | Screen Reports: Monthly | ATM's ranked by monthly surcharge |
| Txns | ATM Statistical | transactions. (Double-click on “Avg |
| | Comparisons | Srchg Txns” label and click “Print |
| | | Preview” for report.) |
| Average Surcharge | Screen Reports: | ATM's ranked by monthly surcharge |
| Amount | Monthly ATM Statistical | amount. (Double-click on “Avg Srchg |
| | Comparisons | Amt” label and click “Print Preview” for |
| | | report.) |
| Percentage | Screen Reports: | ATM's ranked by monthly percent of |
| Transactions | Monthly ATM Statistical | txns surcharged. (Double-click on “% |
| Surcharged | Comparisons | Txns Srchgd” label and click “Print |
| | | Preview” for report.) |
| Missing ATM Day | Audit Checks: Missing | Prints a list of missing calendar day |
| Records | ATM Records: Preview | records that should be investigated. A |
| | Report | calendar day should be on file for every |
| | | day that the terminal might have activity |
| | | of any sort |
| Missing ATM Daily | Audit Checks: Missing | Prints a list of ATM days for which there |
| Settlement Records | ATM Daily Settlement | are no activity records. Helpful in |
| | Records: Preview Report | determining if ATMs are out of cash or |
| | | have a maintenance problem. |
| ATMs With No | ATMs With No | Prints a list of ATM activity records for |
| Transactions | Transactions | which there are no transactions of any |
| | | type. Helpful in determining if ATMs are |
| | | out of cash or have a maintenance |
| | | problem. |
| Processor Daily File | System | Report produced by each Processor Import Utility |
| Capture Reports | Configuration: | showing the records captured for posting into the |
| | Parameters tab | database. This report prints during the initial |
| | | import of a file into the system. The option to set |
| | | this report is located in system configuration. |
| Edit File Posting | Import New | Report produced by the Edit File |
| Report | Data: Print | Posting routine showing the result |
| | Import Edit File - | of attempting to post each record |
| | and -System | into the database. This is an |
| | Configuration: | optional report. The print option |
| | Parameters tab | can be set in System |
| | | Configuration. |
| Rolling 12 Month | ATM Monthly | Prints a report of the past 12 |
| Report | Statistics: | months transaction totals and |
| | Rolling 12 Mo | amounts by month with charts for |
| | Report | the selected ATM |
| ATM Groups | ATM Groups | Lists all ATM Groups, their start |
| | and Members | and end date in the group, and |
| | Display and | each ATM's transaction processor |
| | Printed Reports | and processor terminal ID |
| | Menu | |

1. An ATM management system for enabling efficient operations comprising, in combination,
(a) means for parsing the ATM business transactions and management into an array of separate data-carrying entities including ATM terminals and other types of terminal devices including POS devices and kiosks, the terminals, proprietor(s), providers of cash or other value to be dispensed via ATM terminals, transport and replenish service providers, and also the terminals per se and transactions and events of related respective business surrounding the system,
(b) means associated with each of selected persons or entities or groups of them and the ATMs for providing separate activity data files of each,
(c) means establishing contract terms or other protocols inter-relating each of said persons or entities with the ATMs and transactions and activities,
(d) means for controlling all allowable customer transactions and events of each ATM and terminal back up service transactions and events by the terms or other protocol,
the system as a whole operating in parallel with but not dependent on the selection of bank records or other customer-institution relationship, the system acting in response to financial transaction authorizations and rejections.

2. The system of claim 1 configured for cash dispensing.

3. The system of claim 2 including means for generation of cash orders and replenishments for such terminals.

4. The system of claim 1 including means for generating a database of terminal events as needs and fulfillment.

5. The system of claim 1 including means for grouping ATMs and persons/entities as new pseudo entities incorporated in the database.

6. An ATM management system for enabling efficient operations comprising, in combination,
(a) means for parsing the ATM business transactions and management into an array of separate data-carrying entities including terminal devices, proprietor(s), providers of cash or other value to be dispersed via ATM terminals, transport and replenish service providers, and also the terminals per se and transactions and events of related respective business surrounding the system,
(b) means associated with each of selected persons or entities or groups of them and the ATMs for providing separate activity data files of each,
(c) means establishing contract terms or other protocols inter-relating each of said persons or entities with the ATMs and transactions and activities,
(d) means for controlling all allowable customer transactions and events of each ATM and terminal back up service transactions and events by the terms or other protocol, the system as a whole operating in parallel with but not dependent on the selection of bank records or other customer-institution relationship,
(e) means for generation of cash orders and replenishments for such terminals, and
(f) means for generating a database of terminal events as needs and fulfillment.

7. An ATM management system for enabling efficient operations comprising, in combination,
means for parsing the ATM business transactions and management into an array of separate data-carrying entities including terminal devices, proprietor(s), providers of cash or other value to be dispersed via ATM terminals, transport and replenish service providers, and also the terminals per se and transactions and events of related respective business surrounding the system,
the system as a whole operating in parallel with but not dependent on the selection of bank records or other customer-institution relationship, the system acting in response to authorizations and rejections but not interfering with such processes.

8. The system of claim 7 including means for grouping ATMs and persons/entities as new pseudo entities incorporated in the database.
